(19) United States
(12) Patent Application Publication
(10) Pub. No.: US 2021/0257204 A1
(43) Pub. Date: Aug. 19, 2021

(54) METHOD AND DEVICE FOR SAMPLE INTRODUCTION FOR MASS SPECTROMETRY

(71) Applicant: JP SCIENTIFIC LIMITED, Waterloo (CA)

(72) Inventors: Janusz B. PAWLISZYN, Waterloo (CA); German Augusto GOMEZ-RIOS, Bellefonte, PA (US); Varoon SINGH, Nallasopara (W) (IN); Nathaly REYES GARCES, Bellefonte, PA (US); Marcos TASCON, Berazategui (AR)

(21) Appl. No.: 17/270,950

(22) PCT Filed: Aug. 23, 2019
(86) PCT No.: PCT/CA2019/051162

§ 371 Date: Feb. 24, 2021

Related U.S. Application Data
(60) Provisional application No. 62/722,848, filed on Aug. 25, 2018.
(60) Provisional application No. 62/751,683, filed on Oct. 28, 2018.

(51) Int. Cl. H01J 49/16; H01J 49/04

(52) U.S. Cl. CPC H01J 49/165; H01J 49/0409

(57) ABSTRACT

Methods and devices for generating ionized molecules for analysis in a mass spectrometer are provided. A device comprises a solid substrate having one or more edges for spray ionization, the substrate adapted for receiving extraction phase comprising molecules of interest. The solid substrate may comprise one or more indentations for receiving the extraction phase and desorption solvent. The indentation may extend to one of the edges of the substrate to channel the desorption solution to the edge for spray ionization. The solid substrate may comprise a magnetic portion for retaining magnetic extraction phase deposited thereon. The solid substrate itself may be free of any extraction phase prior to an extraction phase containing the molecules of interest being deposited thereon.

### CROSS REFERENCE TO RELATED APPLICATIONS

This application claims the benefit of priority of U.S. Provisional Patent Application No. 62/722,848 filed on Aug. 25, 2018, and of U.S. Provisional Patent Application No. 62/751,683 filed on Oct. 28, 2018, which are incorporated herein by reference.

### FIELD

The present disclosure generally relates to methods, devices, and systems for one or more of collection, enrichment, and analysis of molecules of interest in mass spectrometry.

### BACKGROUND

Mass spectrometry (MS) is one of the technologies most commonly used for the qualitative and quantitative analysis of molecules of interest in complex matrices. Molecules of interest present on a given sample can be extracted via diverse sample preparation methods such solid phase extraction (SPE), liquid-liquid extraction (LLE) or solid phase micro extraction (SPME). Sample preparation is used to optimize a sample for analysis in a mass spectrometer.

In solid-phase extraction, compounds that are dissolved or suspended in a liquid mixture are separated from other compounds in the mixture according to their chemical and/or physical properties. Solid phase extraction may be used to concentrate and/or purify samples for analysis, for example isolate analytes of interest from a variety of matrices such as blood and urine.

Subsequently these enriched molecules can be introduced into the mass spectrometer, typically, via gas chromatography or liquid chromatography. Although thorough, classical sample preparation workflows coupled with the traditional chromatographic methods can be expensive, time-consuming and burdensome when trying to obtain qualitative or semi-quantitative information. Hence, over the last decade, different technologies, based on the direct interface of the sample to the mass spectrometer, have been developed to reduce cost, sample treatment, total analysis time and workflow simplicity. Such technologies are referred to as direct-sample-to-MS, meaning direct sample to mass spectrometer.

Such technologies that do not include either sample preparation or separation steps in their experimental workflows include paper spray ionization (PSI), direct analysis in real time (DART), rapid evaporative ionization mass spectrometry (REIMS), laser ablation electrospray ionization (LAESI), liquid extraction surface analysis (LESA), desorption electrospray ionization (DESI) and dielectric barrier discharge ionization (DBDI).

Direct-sample-to-MS techniques typically ionize analytes under an ambient environment from condensed-phase samples with minimal or no sample preparation and/or separation. Although direct-sample-to-MS methods have represented a revolution in environmental, forensic, clinical and food applications, their operation generally requires sophisticated and costly equipment such as pneumatic assistance, continuous flow of a solvent or a gas, and electronics to control sample positioning. The rapid development of ambient ionization techniques and direct-to-MS approaches have opened the path for the development of multiple micro extraction technologies direct couple to Mass Spectrometry. Indeed, such developments bring a major opportunity for the introduction of new solid phase microextraction (SPME) applications. To date, different geometries of SPME have being coupled to direct analysis in real-time (DART), desorption electrospray ionization (DESI) and dielectric barrier discharge ionization (DBDI), among others.

In spite of the dramatic reduction in total analysis time, experimental information has proven that, by not including a sample preparation in their operation workflow, these technologies cannot attain the desired limits of quantitation in several applications and can lead to severe instrument contamination.

Aiming to beat this intrinsic limitation of direct-sample-to-MS technologies abovementioned, novel workflows that include a quick sample preparation step, prior to the desorption/ionization step, have been developed. Among them, SPE-MS and SPMEMS workflows have excelled by showing capabilities of reducing the limitations of quantitation typically offer by direct-sample-to-MS technologies without dramatically increasing the total analysis time.

Among the SPME-MS technologies developed to date, coated blade spray (CBS) has shown capabilities of performing sampling, sample preparation and analyte ionization from a single device. The applications of the CBS are not limited to environmental, food, clinical and toxicological applications. Further, devices on which both sample preparation, for example extraction, and ionization are performed are restrictive since extraction phase must be attached to the device. Thus, the same device is used to perform both the extraction and the desorption/electrospray steps. This may be restrictive since the extraction stage is limited to the particular characteristics and geometry of the device.

In spite of the multiple advantages of CBS, there are still applications where CBS cannot efficiently collect the analytes of interest, desorb them efficiently or provide adequate limits of quantitation.

Improvements relating to one or more of analyte collection, analyte enrichment, analyte desorption, and analyte ionization for mass spectrometry are desired.

The above information is presented as background information only to assist with an understanding of the present disclosure. No assertion or admission is made as to whether any of the above might be applicable as prior art with regard to the present disclosure.

### SUMMARY

According to an aspect, the present disclosure is directed to a device for generating ionized molecules of interest for analysis in a mass spectrometer, the device comprising a solid substrate having one or more edges for spray ionization, the solid substrate defining an indentation for receiving desorption solvent and extraction phase containing the molecules of interest.

In an embodiment, at least part of the indentation is in the form of a channel extending to an edge of the solid substrate for guiding desorption solvent containing the molecules of interest towards the edge for spray ionization.

In an embodiment, the channel is disposed at a tip of the solid substrate for guiding desorption solvent containing the molecules towards the tip.

In an embodiment, at least part of the indentation is in the form of a compartment for receiving the desorption solvent and extraction phase, wherein the compartment is connected to the channel.

In an embodiment, a region of the solid substrate defining the indentation comprises no extraction phase.

In an embodiment, the solid substrate comprises no extraction phase prior to receiving the extraction phase comprising the molecules of interest.

In an embodiment, the solid substrate comprises a magnetic portion for attracting magnetic particles of an extraction phase deposited on the solid substrate.

In an embodiment, the magnetic portion at least partly aligns with the indentation.

In an embodiment, the solid substrate has a tip having a substantially triangular shape and being defined by at least two edges that meet at an angle from about 8 degrees to about 90 degrees.

In an embodiment, the solid substrate has a homogeneous thickness from about 0.01 mm to about 2 mm.

In an embodiment, the solid substrate has a length from about 1 to about 10 cm, a width from about 0.1 to about 5 mm, and a thickness from about 0.1 mm to about 2 mm.

In an embodiment, the solid substrate comprises at least one of a metal, a metal alloy, and a polymer.

In an embodiment, the indentation has a substantially square or rectangular cross-section.

According to an aspect, the present disclosure is directed to a method for analyzing molecules previously extracted from a sample onto an extraction phase using a device according to the present disclosure, comprising depositing the extraction phase in the indentation of the solid substrate of the device, applying desorption solvent to desorb the molecules from the extraction phase, ionizing the desorbed molecules using an ionization source to expel ionized molecules from the solid substrate, and analyzing the formed ions by mass spectrometry.

In an embodiment, the extraction phase comprises magnetic particles containing extraction polymer.

In an embodiment, during ionization no solvent is applied to the device.

In an embodiment, the extraction phase is located on a secondary solid substrate device, the method comprising depositing the secondary solid substrate device in the indentation.

In an embodiment, the ionization source in conjunction with the desorption solvent is used to ionize and expel desorbed molecules from the secondary solid substrate device.

In an embodiment, the method further comprises vibrating the solid substrate to promote ionization of the molecules.

According to an aspect, the present disclosure is directed to a method of manufacturing a device for generating ionized molecules of interest for analysis in a mass spectrometer, the method comprising providing a solid substrate having one or more edges for spray ionization, and forming an indentation in the solid substrate for receiving desorption solvent.

In an embodiment, at least part of the indentation is in the form of a channel extending to an edge of the solid substrate for guiding desorption solvent containing the molecules of interest towards the edge for spray ionization.

In an embodiment, the channel is disposed at a tip of the solid substrate for guiding desorption solvent containing the molecules towards the tip.

In an embodiment, at least part of the indentation is in the form of a compartment for receiving the desorption solvent and extraction phase, wherein the compartment is connected to the channel.

According to an aspect, the present disclosure is directed to a device for generating ionized molecules of interest for analysis in a mass spectrometer, the device comprising a solid substrate for receiving magnetic particles of an extraction phase, the solid substrate having one or more edges for spray ionization and comprising a magnetic portion for attracting the magnetic particles.

In an embodiment, the magnetic portion comprises the entire solid substrate.

In an embodiment, the magnetic portion comprises a magnet embedded in or on the solid substrate.

In an embodiment, the solid substrate other than the magnetic portion is substantially non-electrically conductive.

In an embodiment, the device further comprises an electrical conductor extending to an edge or tip region of the solid substrate for applying a voltage to the solid substrate for spray ionization.

In an embodiment, the device further comprises a magnetic shield portion to at least partly shield a portion of the solid substrate from the magnetic field of the magnetic portion.

In an embodiment, the device further comprises a vibration device for applying vibration to the solid substrate to promote reduction in droplet size and ionization of the molecules of interest.

In an embodiment, the device further comprises a heating device for applying heat to the solid substrate to promote desorption of the molecules of interest from the extraction phase.

In an embodiment, the device further comprises a stacking voltage supply for applying a stacking voltage to the solid substrate to concentrate the molecules of interest in a solvent in a region of the solid substrate prior to spray ionization.

In an embodiment, at least a portion of the solid substrate comprises clean-up phase to promote removal of undesired molecules and/or to promote the selective enrichment of the molecules of interest.

In an embodiment, the clean-up phase comprises at least one of a polymer-metal oxide and metallic particles.

In an embodiment, the solid substrate defines an indentation for receiving the magnetic particles.

In an embodiment, the indentation comprises clean-up phase to promote removal of undesired molecules and/or to promote the selective enrichment of the molecules of interest.

In an embodiment, the solid substrate comprises a mesh portion allowing for fluid flow through the solid substrate and capture of magnetic particles.

According to an aspect, the present disclosure is directed to a method for analyzing molecules of interest previously extracted from a sample onto an extraction phase comprising magnetic particles using a device according to the present disclosure, comprising depositing the extraction phase at the magnetic portion of the solid substrate of the device, applying desorption solvent to desorb the molecules from the extraction phase, ionizing the desorbed molecules using an ionization source to expel the ionized molecules from the solid substrate, and analyzing the formed ions by mass spectrometry.

In an embodiment, the method further comprises vibrating the solid substrate to promote ionization of the molecules.

In an embodiment, the method further comprises heating the solid substrate to promote desorption of the molecules from the extraction phase.

In an embodiment, the method further comprises applying a stacking voltage to the solid substrate to concentrate the molecules in a solvent in a region of the solid substrate prior to spray ionization.

In an embodiment, the applying the stacking voltage involves applying voltage for a predetermined time to the solid substrate that is below a threshold voltage for causing ionized molecules to be expelled from the solid substrate, then increasing the voltage until ionized molecules are caused to be expelled from the solid substrate.

In an embodiment, the method further comprises, prior to the applying the stacking voltage, applying a stacking solvent on the solid substrate proximate the desorption solvent, wherein the stacking solvent is different than the desorption solvent.

According to an aspect, the present disclosure is directed to a device for ionizing molecules of interest for analysis in a mass spectrometer, the device comprising a solid substrate for receiving particles of an extraction phase comprising the molecules of interest, the solid substrate having one or more edges for spray ionization of the molecules of interest, and comprising no extraction phase prior to receiving the extraction phase particles comprising the molecules of interest.

The foregoing summary provides some aspects and features according to the present disclosure but is not intended to be limiting. Other aspects and features of the present disclosure will become apparent to those ordinarily skilled in the art upon review of the following description of specific embodiments in conjunction with the accompanying figures. Accordingly, the drawings and detailed description are to be regarded as illustrative in nature and not restrictive.

### BRIEF DESCRIPTION OF THE DRAWINGS

Embodiments of the present disclosure will now be described, by way of example only, with reference to the attached Figures.

FIG. 1 is an illustration of an example experimental setup and process for blade-spray desorption and ionization.

FIGS. 2A and 2B are top and side views, respectively, of an example solid substrate positioned in a substrate holder.

FIGS. 3A and 3B are top views of example geometrical configurations of solid substrates.

FIG. 3C is a side view of the solid substrate of FIG. 3A.

FIG. 4 is an example magnetic blade spray device comprising a solid substrate in the form of a magnetic composite tape.

FIG. 5 is a transparent view of an example blade spray device including a solid substrate comprising a magnet, a heating device, and a vibrational device.

FIG. 6 is an exploded view of an example coated blade spray device.

FIG. 7 is a semi-transparent exploded view of an example magnetic blade spray device.

FIG. 8A is an illustration of an example experimental setup and process for blade-spray desorption and ionization using a device similar to the one of FIG. 6.

FIG. 8B is an illustration of an example experimental setup and process for blade-spray desorption and ionization using a device similar to the one of FIG. 7.

FIG. 9 is an illustration showing the stacking of desorption solution containing molecules of interest, and a stacking solvent, on a magnetic or polymer blade spray device prior to the desorption solution being sprayed by the device.

FIG. 10A is an illustration similar to FIG. 9 but after a stacking voltage reaches the electric potential threshold of the solvents for spraying has been reached.

FIG. 10B is an illustration similar to FIG. 10A but after spraying has occurred where residual solvent is shown.

FIG. 11 is a view of an example direct blade spray device adapted for receiving and holding a secondary solid substrate.

FIG. 12 illustrates a ribbon-like structure to facilitate automated introduction of multiple spray devices for use with a mass spectrometer.

FIG. 13 is an illustration of an experimental setup and process used in an example for magnetic blade-spray desorption and ionization using a spray device.

FIG. 14A is a linear regression graph illustrating quantitative analysis of a human urine sample spiked with cocaine.

FIG. 14B is a linear regression graph illustrating quantitative analysis of a human urine sample spiked with fentanyl.

FIG. 15A is a linear regression graph illustrating quantitative analysis of a human plasma sample spiked with diazepam.

FIG. 15B is a linear regression graph illustrating quantitative analysis of a human plasma sample spiked with sertraline.

FIG. 16 is a semi-transparent, exploded view of an example blade spray device similar to the device of FIG. 7 but wherein its channel comprises a layer of clean-up phase.

FIG. 17 is a diagram of a blade spray system having a mass spectrometer, a blade spray ionization device, and two additional sprayers.

FIG. 18 is an example blade spray device having an indentation in the form of a channel for receiving extraction phase and desorption solution.

FIG. 19 is an example blade spray device having an indentation in the forms of a compartment and a channel.

FIGS. 20A-20D are linear regression graphs illustrating quantitative analysis of human urine samples spiked with propranolol, fentanyl, sertraline, and methamphetamine, respectively, in an example.

FIGS. 21A-B are linear regression graphs illustrating quantitative analysis of human blood samples spiked with fentanyl and diazepam, respectively, in an example.

The relative sizes and relative positions of elements in the drawings are not necessarily drawn to scale. For example, the shapes of various elements and angles are not necessarily drawn to scale, and some of these elements may be arbitrarily enlarged and/or positioned to improve the readability of the drawings. Further, the particular shapes of the elements as drawn are not necessarily intended to convey any information regarding the actual shape of the particular elements, and have been solely selected for ease of recognition in the drawings.

### DETAILED DESCRIPTION

There is an unmet desire for a green-chemistry technique capable of combining two or more of sampling, sample preparation, efficient analyte enrichment, efficient analyte desorption, and ionization on a single device.

In an aspect, the present disclosure generally relates to systems and methods to collect and enrich analytes of interest present on a fluid, surface, or tissue, and subsequently generate ions for mass spectrometry.

The devices and methods disclosed herein are generally directed to spray ionization devices and related techniques. Such devices may include a solid substrate having one or more edges which may be used without further modification as an ionization device for mass spectrometry. Electrospray ionization at atmospheric pressure (or near atmospheric pressure) generally benefits from solid substrates with sharp features, such as one or more corners, edges, or points. Some of the present devices are “blade” type devices meaning that they have a blade-style solid substrate, meaning their solid substrate is substantially flat and thin, and has at least one edge for spray ionization. The device may be capable of performing one or more of analyte collection, analyte enrichment, and analyte ionization.

In an aspect, the present disclosure is directed to a spray ionization device that comprises no extraction phase forming part of the device in a region where molecules of interest are to be deposited. The stage for extracting the molecules of interest from a sample is therefore not limited to the particular characteristics and geometry of the device.

In an aspect, the present disclosure is directed to a spray ionization device having a solid substrate comprising at least one groove or other indentation for receiving desorption solution and optionally extraction phase containing molecules of interest.

Some aspects according to the present disclosure are generally based on operational principles of previous coated blade spray techniques but include improvements that provide better performance and sensitivity. It is to be noted that extraction phase coatings of solid substrates of devices are not necessary for all embodiments according to the present disclosure.

In particular, in an aspect, the present disclosure generally relates to devices and methods for desorption and ionization where extraction phase containing molecules of interest are received directly onto the device, where the molecules were previously extracted from a sample onto the extraction phase. Accordingly, sample preparation, for example solid phase extraction, will have been performed before the extraction phase is placed onto the device. In this way, the device is not used to perform both the extraction and the desorption/electrospray stages. The extraction stage is therefore not limited to the particular characteristics and geometry of the device.

In an aspect, the present disclosure is directed to a device for generating ionized molecules for analysis in a mass spectrometer, where the device includes a solid substrate for receiving magnetic particles of an extraction phase. The solid substrate has a magnetic portion for attracting the magnetic particles. The solid substrate may also have one or more edges for spray ionization. In use, the magnetic particle extraction phase containing the molecules may be deposited on the solid substrate. The magnetic portion of the solid substrate may collect and/or retain the magnetic particles in position while the molecules are desorbed from the magnetic particle extraction phase and are then ionized. The ionized molecules may then be expelled from the solid substrate and analyzed using mass spectrometry.

In an aspect, the present disclosure is directed to a device for generating ionized molecules for analysis in a mass spectrometer, where the device includes a solid substrate having one or more edges for spray ionization. The solid substrate comprises an indentation for receiving desorption solvent and extraction phase containing the molecules. Prior to receiving the extraction phase, the solid substrate itself may contain no extraction phase, meaning the extraction may have been performed separately from the device. At least part of the indentation may be in the form of a channel for guiding desorption solvent containing the molecules towards an edge of the solid substrate for spray ionization. Further, at least part of the indentation may be in the form of a compartment for receiving the extraction phase and the desorption solvent. The compartment may be fluidly connected to the channel.

In certain aspects, the present disclosure relates to systems and methods for ion generation using a coated solid substrate that substantially prevents the contamination and/or damage of the mass spectrometer analyzer because the systems and methods extracts the analytes of interest while discarding sample components such as proteins, carbohydrates, salts and detergents.

At least three general categories or types of devices are described herein. One category is coated blade spray devices, where a solid substrate of the device is in the form of a blade (meaning it has edges for ionization), and at least a portion of the solid substrate comprises extraction phase for extracting molecules of interest from a sample. Another category is magnetic blade spray devices, where at least a portion of the solid substrate is magnetic for attracting magnetic extraction phase that contains the molecules of interest. Another category is direct blade spray devices, where a secondary sampling device, onto which molecules of interest have been previously been extracted, may be placed onto the main device for desorption, introduction and ionization of extracted molecules into the mass spectrometer. The categories are not mutually exclusive, meaning that devices may fall into one or more categories.

Some devices and methods described herein use a solid substrate which may comprise at least one groove or other indentation where either a liquid or a secondary solid substrate may be deposited for analysis; where the secondary solid substrate may be a wire, a pin, a needle, a blade, a powder, a particle, or any other suitable structure; where the liquid sample may be an extract from a sample preparation device or technique. In some embodiments, the device may comprise a plurality of indentations.

The extraction phase used to enrich the analytes may include but are not limited to solid phase microextraction (SPME) particles, solid phase extraction particles, bare magnetic particles, coated magnetic particles and functionalized magnetic particles. The extraction phase may comprise a biocompatible polymer. In some embodiments, the extraction phase may be in the form of a coating, and/or may have a thickness in the approximate range of about 1 nm to about 500 μm.

The terms “analyte”, “analyte of interest” and “molecule of interest” used herein are generally used interchangeably. Further, the terms “spray ionization device” and “spray device” are generally used interchangeably. Further, the terms “solvent” and “solution” are generally used interchangeably herein.

Example embodiments according to the present disclosure are now described with reference to the drawings.

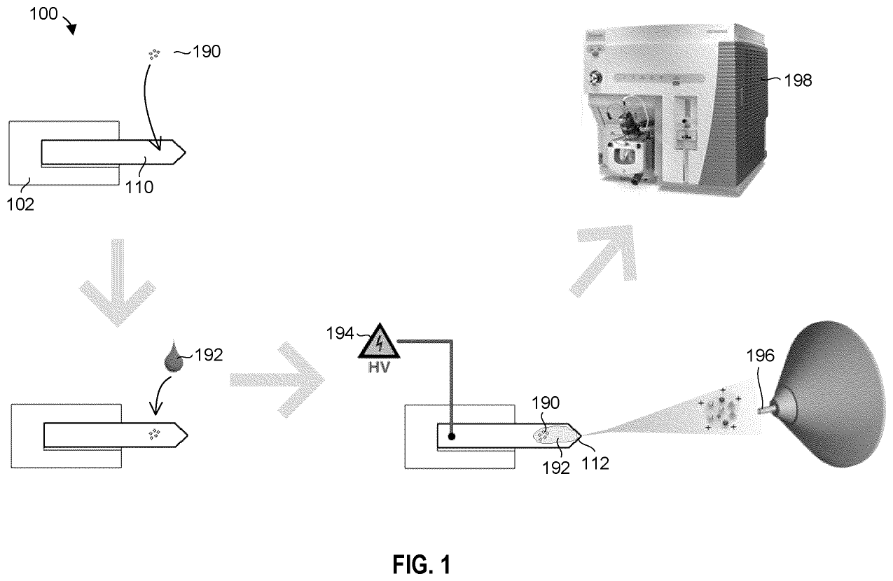

FIG. 1 is an illustration of an example experimental set up for desorption and spray ionization. A device 100 comprising a solid substrate 110 is provided in a device holder 102. At least a portion of solid substrate 110 is magnetic for attracting and retaining magnetic particles that are deposited onto the device.

Various steps of an example analytical process are shown.

Molecules of interest previously extracted from a sample, whether a liquid sample or a solid sample, onto an extraction phase, in this example magnetic particles 190, may be deposited onto solid substrate 110. In the example, solid substrate 110 is in the form of a blade-style solid substrate, meaning solid substrate 110 is substantially flat and thin, has at least one edge for spray ionization.

A desorption solution 192, for example a solvent or a mixture of solvents, may be applied to the magnetic particles 190 on solid substrate 110 for a period of time to wet the magnetic particles 190 to desorb and concentrate the molecules previously adsorbed by the magnetic particles extraction phase 190.

A voltage from a high voltage (HV) source 194 may then be applied to solid substrate 110 to form tiny droplets, for example microsized or nanosized, of desorption solution containing the molecules of interest. The droplets may be formed at an edge 112 of the solid substrate 110, and then expelled from solid substrate 110.

The droplets may then be received at an inlet 196, such as an ion-transfer capillary, of a mass spectrometer 198 and analyzed.

According to an aspect of the present disclosure, the solid substrate may have a magnetic portion which may collect and/or retain magnetic particles, such as coated or functionalized magnetic particles, bare magnetic particles, or magnetic molecules. The magnetic portion may be the entire solid substrate, or just a part of the solid substrate. In an embodiment, the entire solid substrate may be formed of magnetic material. In another embodiment, magnetic material may be embedded in or positioned on or at a non-magnetic portion of the solid substrate. For example, a portion of the solid substrate may be made of nonmagnetic material and magnetic material may be embedded in the nonmagnetic portion. A magnetic material may comprise one or more of a magnets, a magnetic tape, a magnetized metal, a magnetized mesh, a magnetized polymer, a polymer embedded with magnetic particles and supported on either metal, paper, wood, and soft iron material.

In an embodiment, the portion of solid substrate 110 that is not magnetic, meaning the non-magnetic portion, is not sufficiently electrically conductive to apply the electric potential to the substrate. A separate electrical conductor, such as conductive tape (not shown), may be used with the solid substrate to extend from a connection point to the voltage source along the substrate to end tip or end region of the solid substrate.

In addition, a portion of the solid substrate may include a magnetic shield for shielding a side of the solid substrate that is opposite to the side on which magnetic particles are to be attracted so that the magnetic field of the magnet only attracts particles on one side of the solid substrate. For example, the magnetic shield may be in the form of one or more of magnetic flux shielding, electromagnetic field shielding, and inclusion of permanent magnet sheet. Magnetic shield may be disposed above or on the solid substrate, embedded within the solid substrate, or formed integrally with the solid substrate. Magnetic shield may be made of or at least comprise, for example, nickel-iron alloys.

In an embodiment, the solid substrate may have a length from about 1 to about 10 cm; a width from about 0.1 mm to about 5 mm; and a thickness from about 100 micrometers to about 2 millimeters. In some embodiments, the solid substrate has a length in the range of about 1 cm to about 10 cm, a width in the range of about 0.5 mm to about 10 mm, and/or a thickness in the range of about 0.5 mm to about 10 mm. In some embodiments, it is preferable that the length is about 5 cm, the width is about 5 mm, and/or the thickness is about 1 mm. Solid substrates having these dimensions allow the substrates to be used with high-throughput instruments.

In an embodiment, the solid substrate is preferably substantially flat. The solid substrate may have a pointed end or tip. The pointed tip of the solid substrate may have an angle from 8° to 180°. In an embodiment, angle is within the range of 8° to 90°. In an embodiment, it is preferred that the solid substrate has a pointed tip that has an angle from 20° to 60°. The solid substrate may have an end or tip that is curved or elliptical.

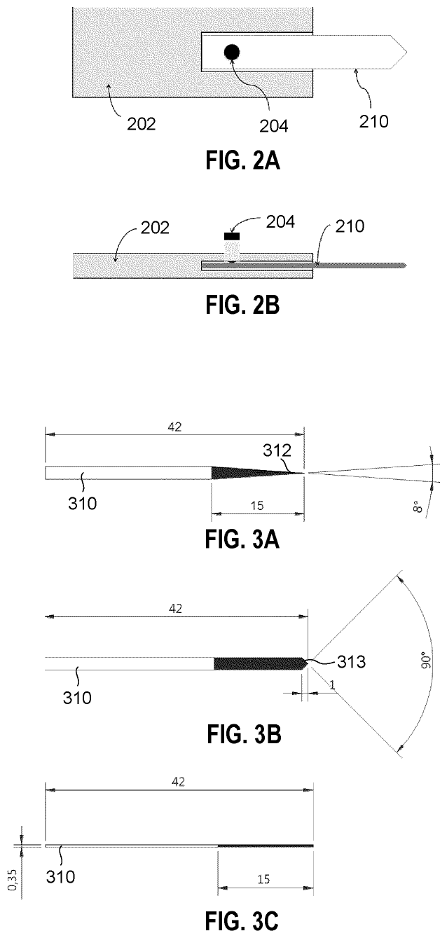

FIGS. 2A and 2B are top and side views, respectively, of an example solid substrate 210 positioned in a substrate holder 202. Solid substrate 210 may be retained in holder 202 by a retaining mechanism 204, such as a clip or clamp.

FIGS. 3A and 3B are top views of example geometrical configurations of solid substrates that are approximately 42 mm long and 0.35 mm thick. FIG. 3A shows a tip 312 having an angle of 8°, while FIG. 3B shows a tip 313 having an angle of 90°. FIG. 3C shows a side view of the solid substrate of FIG. 3A.

Particular methods according to the present disclosure may generate, using the high electric field, miniscule droplets (e.g. micron scale) at an edge of the solid substrate. Electrospray ionization (ESI) is a technique for producing ions using an electrospray whereby high voltage is applied to a liquid to create an aerosol. Electrospray ionization at atmospheric (or near atmospheric pressure) benefits from solid substrates with sharp features, such as one or more corners, edges, or points. In particular examples, the solid substrate is shaped to have a macroscopically sharp point, such as a point of a triangle (e.g. sharp tip of a “gladius sword”), for ion generation. One or more of such points may be formed by a plurality of edges that meet to form the point(s). Different embodiments may have different tip widths. Example solid substrates are shown in FIGS. 2A-3B.

As mentioned above, no pneumatic assistance is required to transport the droplets to the inlet of the mass spectrometer. Ambient ionization of analytes is realized on the basis of these charged droplets, offering a simple and convenient approach for mass analysis of analytes previously enriched or pre-concentrated on the solid substrate.

In other embodiments, however, other types of ionization may be used, such as photoionization (for example using electromagnetic radiation) and/or atmospheric pressure chemical ionization.

The solid substrate may comprise or consist of any suitable material or materials, for example a metal, a metal alloy, a glass, a fabric, a polymer, a polymer metal oxide, or any combination thereof.

The solid substrate may have a portion coated with an extraction phase such as an extraction polymer. In an embodiment, the extraction phase coating of the solid substrate may be made of an extraction polymer and/or a polymer-metal oxide composite, and/or cover an area from about 0.001 mm² to about 100 mm² of the surface of the solid substrate. In an embodiment, the extraction phase coated on the substrate is inhomogeneous along the length of the solid substrate due to variations in the composition of the extraction phase along the length of the solid substrate, and/or due to variations in the thickness of the extraction phase along the length of the solid substrate, and/or due to variations in the topographical characteristics of the solid substrate.

In some embodiments, a portion or the entirety of the solid substrate is coated with extraction phase. In an embodiment, the solid substrate is preferably coated with enough extraction polymer to result in a coated area of at least 0.01 mm². In various examples, the area is from about 0.1 mm² to about 100 mm², and preferably about 25 mm². Since the amount of analyte is proportional to the amount of coating on the solid substrate, a substrate having a coated area less than 0.01 mm² may still generate ions, but the signal may not last for a desirable time. The extraction polymer may be a biocompatible polymer. For example, in some embodiments that employ a technique referred as stacking, described further below, the solid substrate may be a polymer substrate coated with extraction phase, at least in one region. The solid substrate may also have a separate electrical conductor for supplying high voltage for ionization.

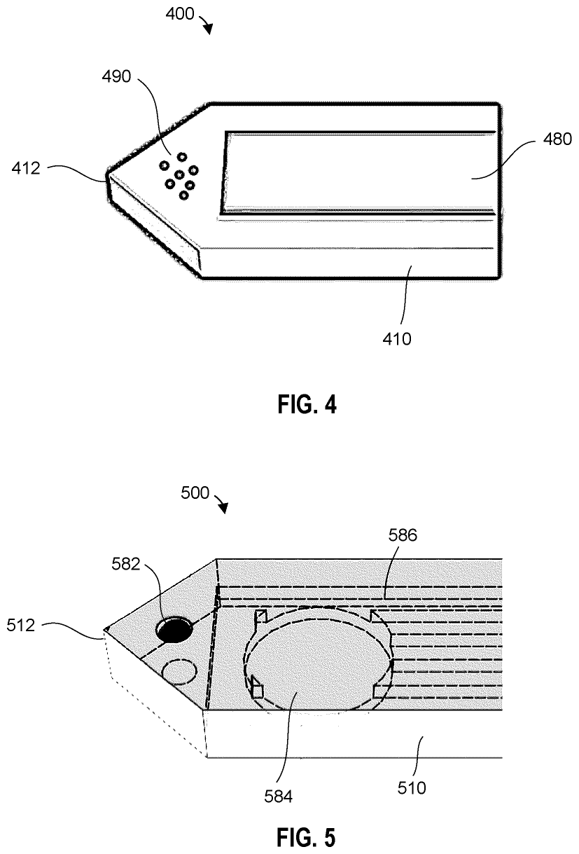

FIG. 4 is an example magnetic blade spray device 400 comprising a solid substrate 410 in the form of a magnetic composite tape 410. Extraction phase in the form of magnetic particles 490 is positioned on magnetic solid substrate 410 in the region of an edge 412 of solid substrate 410, which is in the form of a triangular tip. An electrical conductor in the form of copper tape 480 is positioned on solid substrate 410 to enable an electric potential to be applied to solid substrate 410 to perform electrospray ionization on a solution containing molecules of interest that have been desorbed from the magnetic particles extraction phase 490. A separate electrical conductor, such as copper tape 480 or any other type of tape or conductor, may be used when the solid substrate itself is not sufficiently electrically conductive to apply the electric potential to the substrate.

FIG. 5 is a transparent view of an example blade spray device 500 including a solid substrate 510 comprising an electrical conductor 582, a magnetic portion 584, a heating device, and/or a vibrational device. In this embodiment, the heating and vibrational devices are a combined heating and vibrational device 586. The heating device may be embedded or otherwise positioned in/on device solid substrate 510 below magnetic portion 584 and close to tip 512 of solid substrate 510 to generate ions by vibration and to promote the release of molecules from the extraction phase when the heating device is used.

Electrical conductor 582 may be positioned in the region of the tip 512 of the solid substrate 510 for spray ionization at tip 512. Electrical conductor 582 may be any suitable device for use in applying an electric potential at substrate 510, including a wire, a metal tape, a conductive polymer, a polymer embedded with metal particles, a printed circuit board, graphene, or a combination thereof. An electrical conductor circuit may be embedded within the solid substrate, or be otherwise electrically coupled to the solid substrate.

Magnetic portion 584 may be used to capture and retain magnetic particles (not shown) on substrate 510. Magnetic portion 584 may comprise a magnet embedded in, or otherwise positioned at, solid substrate 510. Magnet 584 may comprise one or more magnets.

Heating and vibrational device 586 may be used for applying heat to solid substrate 510 to promote desorption of molecules from an extraction phase on substrate 510. More specifically, heating device and vibrational 586 may apply heat in the region of magnetic portion 584 of solid substrate where extraction phase magnetic particles are deposited. Heating and vibrational device 586 may be any suitable device for applying heat to substrate 510, including a heating tape, a heating wire, a heating cable, a Peltier heater, a Peltier cooler, or a combination thereof. Heating and vibrational device 586 may be embedded within the solid substrate, or be otherwise thermally coupled to the solid substrate, for example in a region below magnetic portion 584.

Heating and vibrational device 586 may be used for applying vibration to the solid substrate to promote ionization of the molecules. Heating and vibrational device 586 may comprise any device suitable for applying vibration to the solid substrate 510, including one or more of a piezoelectric, a vibrational motor, an ultrasonic vibrator, or a combination thereof. A vibrational device may be embedded within the solid substrate, or be otherwise mechanically connected to the solid substrate.

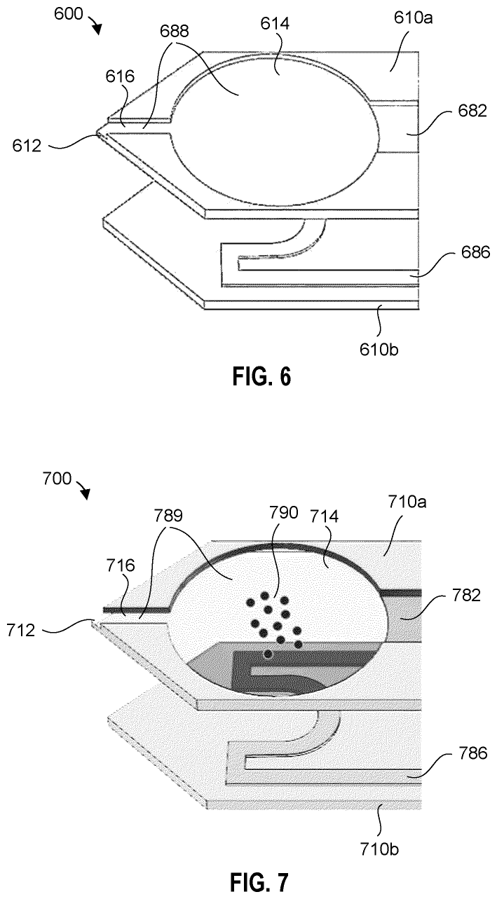

FIG. 6 is an exploded view of an example coated blade spray device 600 including a solid substrate, which comprises first substrate 610a and second substrate 610b shown in an exploded view. In an embodiment, first substrate 610a and second substrate 610b may be made of substantially the same material. Device 600 further comprises an electrical conductor 682, a combined heating and vibrational device 686, and a coating of extraction phase 688 on substrate 610a, such as solid phase micro extraction (SPME). It is noted that in another embodiment, the heating and vibrational devices may be separate devices. Coating of extraction phase 688 may positioned at an indentation in substrate 610a. The indentation may be at least partly in the form of a compartment 614, for example for receiving desorption solution, and/or a channel 616 for channeling desorption solution containing desorbed molecules of interest toward tip 612 of solid substrate 610a for spray ionization. In use, prior to desorption and ionization, molecules of interest may be adsorbed by extraction phase 688.

FIG. 7 is a semi-transparent, exploded view of an example magnetic blade spray device 700 including a solid substrate, which comprises first substrate 710a and second substrate 710b shown in an exploded view. Device 700 further comprises an electrical conductor 782, a coating or layer 789, and a combined heating and vibrational device 786. It is noted that in another embodiment, the heating and vibrational devices may be separate devices. Magnetic particles extraction phase 790 deposited at magnetic region of substrate 710 are also shown. Coating 789 may comprise a magnetic region or layer, such as a polymer magnetic layer, for retaining magnetic particles on solid substrate 710a. Coating 789 may be positioned at an indentation in substrate 710a. The indentation may be at least partly in the form of a compartment 714, for example for receiving extraction phase and/or desorption solution. Additionally or alternatively, the indentation may be at least partly in the form of a channel or groove 716 for channeling desorption solution containing desorbed molecules of interest toward tip 712 of solid substrate 710a for spray ionization.

Where the solid substrate comprises at least two indentations, some or all of the indentations, such as grooves, may have different tridimensional shapes.

In use, after magnetic particles 790 have been deposited onto solid substrate 710a in container region 714, desorption solution may be added to desorb molecules of interest from magnetic particles 790. The desorption solution containing the desorbed molecules of interest may then be directed in channel 716 toward tip 712 and then ionized and expelled from substrate 710a into a mass spectrometer.

Furthermore, according to the present disclosure, in some embodiments, a spray ionization device (not shown) may comprise a gas supply device to enhance ionization of molecules of interest. A gas may be used to evaporate the droplets of solvents to reduce their size and desolvate the ions. The gas supply device may comprise either a tube, pipe, or a microfluidic channel, and may be embedded in the solid substrate.

Furthermore, according to the present disclosure, in some embodiments, a portion of the solid substrate may have the shape or form of a mesh with sufficiently open structure to allow fluid to flow through the mesh and to catch particles such as magnetic particles. A support structure may be connected to the mesh to provide stability to the mesh. The mesh may be magnetic to capture magnetic particles, such as bare or coated magnetic particles, or magnetic molecules. In another embodiment, rather than a portion of the solid substrate comprising the mesh, another substrate comprising mesh may be used to conduct the spray ionization.

According the present disclosure, a mesh substrate is a substrate that allows a fluid to flow through the substrate. In an embodiment, a solid substrate may be comprised of mesh as opposed to a substrate only having a portion of which that comprises mesh. A mesh substrate may comprise a plurality of connected or impregnated wires, filaments or strings, for example in a grid. When the mesh substrate comprises a plurality of connected or impregnated wires, filaments or strings, the wires, filaments or strings may have any suitable diameter, for example from micrometer to millimeters.

In an embodiment, the diameter of the wires, filaments or strings is preferably in the range of about 50 micrometers to about 0.5 millimeters. In an embodiment, the diameter is more preferably about 94 micrometers. The number of wires, filaments or strings per square inch may be from 20×20 to 80×80. In an embodiment, the number of wires, filaments or strings per square inch is preferably 74×74. The mesh substrate may have an open area of about 20% to about 70%. In some embodiments, mesh substrates with a greater percent open area are preferable since they interfere less with fluid flowing through the mesh and, accordingly, provide less variable results when the mesh is being desorbed. In some embodiments, mesh substrates more preferably have an open area of about 50% to about 60%.

The mesh substrate, such as when the mesh substrate comprises wires, filaments or strings, may include a metal, or a metal alloy, or a polymer substrate. In some embodiments, mesh substrates that conduct heat are preferred since the conducted heat increases the desorption of sorbed analytes. In some embodiments, the substrate may comprise one or more of stainless steel, nitinol, nickel, titanium, aluminum, brass, iron, bronze, or polybutylene terephthalate. Mesh substrates may also be formed from materials that can be used in 3D printing. When the substrate is 3D printed, it may be printed using any material suitable for 3D printing, such as acrylonitrile butadiene styrene (ABS), polycarbonate-ISO (PC-ISO), polycarbonate (PC), polycarbonate-acrylonitrile butadiene styrene (PC-ABS), polyetherimide (such as ULTEM™), or polyphenylsulfone (PPSF).

In some embodiments, it is particularly beneficial to use a metal with shape memory properties, such as nitinol, when the coated mesh substrate is used in a method that includes insertion into a tissue or agitation at high speeds. Using a metal with shape memory properties in such methods may enable the substrate to maintain, for example, a flat shape. In other examples, the polymer substrate may include a material synthesized from one or more reagents selected from the group consisting of styrene, propylene, carbonate, ethylene, acrylonitrile, butadiene, vinyl chloride, vinyl fluoride, ethylene terephthalate, terephthalate, dimethyl terephthalate, bis-beta-terephthalate, naphthalene dicarboxylic acid, 4-hydroxybenzoic acid, 6-hyderoxynaphthalene-2-carboxylic acid, mono ethylene glycol (1,2 ethanediol), cyclohexylene-dimethanol, 1,4-butanediol, 1,3-butanediol, polyester, cyclohexane dimethanol, terephthalic acid, isophthalic acid, methylamine, ethylamine, ethanolamine, dimethylamine, hexamthylaminediamine (hexane-1,6-diamine), pentamethylenediamine, methylethanolamine, trimethylamine, aziridine, piperidine, N-methylpiperideine, anhydrous formaldehyde, phenol, bisphenol A, cyclohexanone, trioxane, dioxolane, ethylene oxide, adipoyl chloride, adipic, adipic acid (hexanedioic acid), sebacic acid, glycolic acid, lactide, caprolactone, aminocaproic acid and blends of two or more materials synthesized from the polymerization of these reagents.

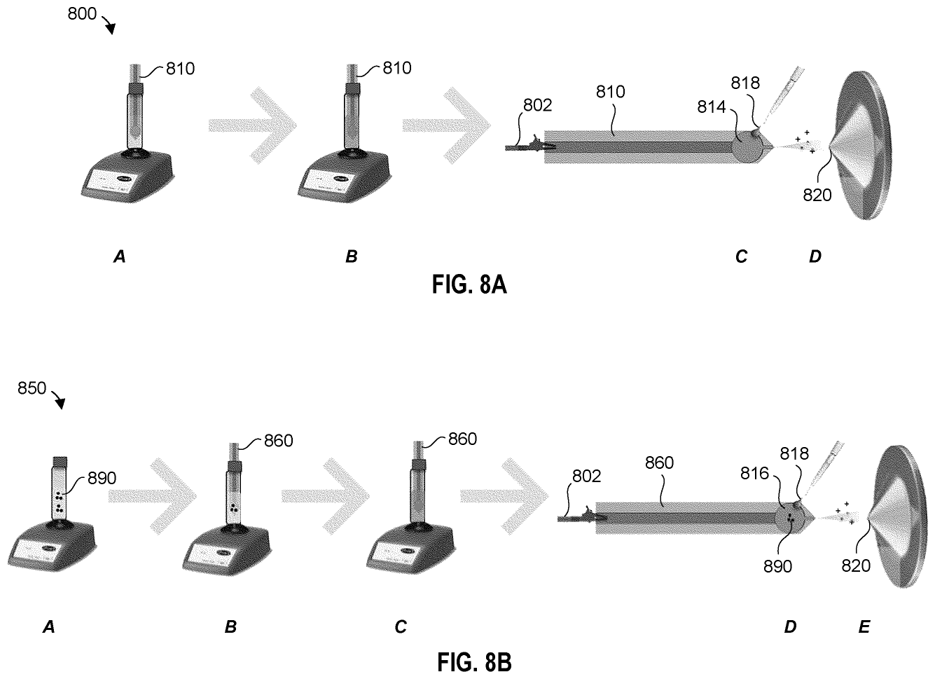

FIG. 8A is an illustration of an example experimental setup and process 800 for blade-spray desorption and ionization using a device similar to the one of FIG. 6. Solid substrate 810 is electrically connected to an electrical source 802. At stage A, as labeled in FIG. 8A, extraction/sampling is performed (e.g. up to 1 minute) on 300 μL of biofluid, such as urine or plasma, using 3200 rpm vortex agitation. At stage B, quick rinsing is performed (5 seconds, or 10 seconds for plasma) using 300 μL of water (LC/MS grade) using 3200 rpm vortex agitation. At stage C, approximately 10 μL of desorption solution 818 is added to the compartment 814 of substrate 810 to perform desorption for approximately 20 seconds. Desorption solution may comprise 0.1% FA, (95:5) MeOH:Water, 10 mM AcNH₄. Compartment may have a coating of extraction phase, and during desorption, molecules of interest are desorbed from the extraction phase. At stage D, high voltage of approximately 5.5 kV from source 802 is applied to solid substrate 810 for approximately 5 seconds to ionize the molecules of interest, whereby the molecules of interest are then be expelled from the tip of substrate 810 toward inlet 820 of a mass spectrometer. Heating and/or vibration may be applied to solid substrate 810 to promote desorption and/or ionization, respectively, of the molecules of interest.

FIG. 8B is an illustration of an example experimental setup and process 850 for blade-spray desorption and ionization using a device similar to the one of FIG. 7. Solid substrate 860 is electrically connected to an electrical source 802. At stage A, as labeled in FIG. 8B, extraction/sampling is performed (e.g. up to 1 minute) on 300 μL of biofluid, such as urine or plasma, using 3200 rpm vortex agitation. At stage B, magnetic particles extraction phase 890 is collected in the magnetic compartment 816 of substrate 860 without using any agitation. At stage C, quick rinsing is performed (5 seconds, or 10 seconds for plasma) using 300 μL of water (LC/MS grade) using 3200 rpm vortex agitation. At stage D, approximately 10 μL of desorption solution 818 is added to the compartment 816 of substrate 810, where magnetic particles 890 are located, to perform desorption for approximately 20 seconds. Desorption solution may comprise 0.1% FA, (95:5) MeOH:Water, 10 mM AcNH₄. During desorption, molecules of interest are desorbed from the magnetic particles extraction phase 890. At stage E, high voltage of approximately 5.5 kV from source 802 is applied to solid substrate 860 for approximately 5 seconds to ionize the molecules of interest, whereby the molecules of interest are then be expelled from the tip of substrate 860 toward inlet 820 of a mass spectrometer. Heating and/or vibration may be applied to solid substrate 810 to promote desorption and/or ionization, respectively, of the molecules of interest.

In some embodiments, a technique referred to as stacking may be used. In stacking, rather than applying the full electric potential (i.e. voltage) to the solid substrate immediately after desorption, a lower electric potential that does not expel ionized molecules (e.g. spraying) is first applied. This allows time for the molecules of interest to transfer from the extraction phase to the desorption solvent. The electric potential may then be gradually increased up to the full electric potential, which causes the ionized molecules to be expelled from the solid substrate. When the substrate is non-conductive, the desorption species focus (stacking effect) in different zones according to their electrophoretic mobilities. This is particularly visible when the interface between two media varying in conductivity is created. The stacking may produce a signal at the mass spectrometer that is more constant than transient since the molecules of interest have more time to desorb and thus become more concentrated (focused) in the desorption solution before, they are expelled towards the mass spectrometer. In contrast, when stacking is not used, the signal may be more transient as the rate of desorption changes more drastically over the time period during which the ionized molecules are expelled from the solid substrate into the mass spectrometer. In stacking, a stacking solvent different from the desorption solvent may be used to cause or promote the desorption solvent to remain on the blade and not to get sprayed at a lower electric potential. The stacking solvent may be water or other solvent which has a higher electric potential threshold, meaning it takes a higher electric potential to generate a spray, compared to a lower electric potential of the desorption solvent. The stacking solvent may be applied to the solid substrate just before and/or during ionization. In a mere example, a desorption solution may be applied, then after approximately 12 seconds, an initial electric potential of 3000 V may be applied, and then gradually increased to 5500 V. In some embodiments, the time period during which the potential is increased may in the range of a few seconds up to several minutes.

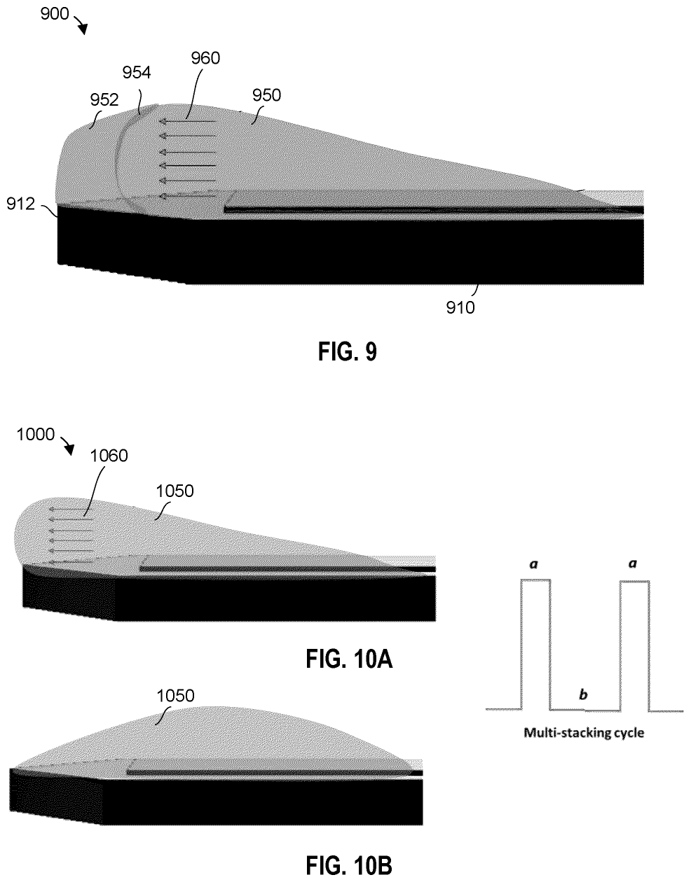

FIG. 9 is an illustration showing the stacking of solution containing molecules of interest, and a stacking solution, on a magnetic or polymer blade spray device 900, prior to the desorption solution being sprayed by the device. Blade spray device 900 has a solid substrate 910, with or without an extractive phase coating, and a a stacking solution 952 that is different than the desorption solution 950 is used. Until the applied stacking voltage reaches a level, desorption solution 950 and staking solution 952 are not miscible, meaning they do not mix. A contact interface 954 between the two solutions 952, 954 is shown. Stacking solution 952 is positioned in a region of tip 912 of solid substrate 910. Arrows 960 represent the stacking of solution at a Taylor cone formation for the stacking solution. In this example, the stacking is shown when the applied electric potential is around 5500 V.

In use, two different solutions are used to concentrate the analytes into the desorption solutions while increasing the electric potential simultaneously. The purpose of the first solution, which is applied close to the tip, is to prevent the second solution (primary function is to do desorption of analytes from the coating) from being electrosprayed at a lower electric potential. When the applied electric potential is ramped slowly upward from 3000-5500 V, this ramping creates a rippling effect in the two solutions. This motion helps the analytes to get transferred into the solution and also concentrates analytes in the solution since the solution is prevented from being sprayed at the lower electric potentials. When the threshold of electric potential reaches beyond the surface tension of the binary or ternary solvents, desorption solution is sprayed, whereby concentrated analytes are ionized and then detected by the mass spectrometer.

FIG. 10A is an illustration similar to FIG. 9 but after a stacking voltage reaches the electric potential threshold of the solvents for spraying has been reached. At this stage, the desorption solution 950 and stacking solution 952 become or are miscible, meaning they mix to form solution 1050 on device 1000. Accordingly, contact interface 954 between desorption solution 950 and stacking solution 952 shown in FIG. 9 disappears. Arrows 1060 represent the spraying after stacking of analytes in mixed solution 1050 at a Taylor cone formation. In this example, the stacking is shown when the applied electric potential is around 4000 V.

In use, multi-stacking may be performed whereby the process described in the preceding paragraph may be repeated over and over to get multiple signals and quantify the analytes to get replicates from the same device 1000. In practice, it has been observed that the analytes extracted by the extraction phase do not get completely desorbed and then the same device 1000 and residual solution left over after spraying may be used to confirm the analysis or repeat it again.

FIG. 10B is an illustration similar to FIG. 10A but after spraying has occurred where residual solution 1050 is shown on device 1000.

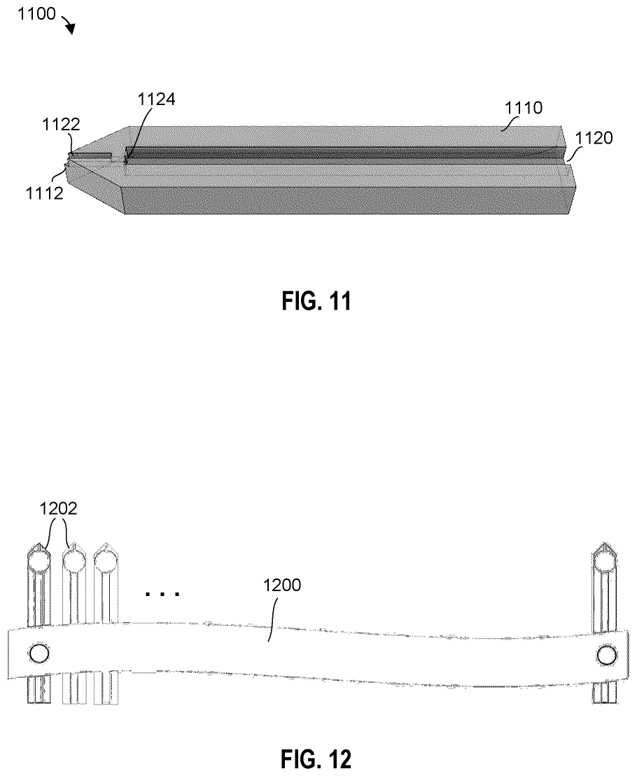

FIG. 11 is a view of an example direct blade spray device 1100 adapted for receiving and holding a secondary solid substrate (not shown). The solid substrate 1110 of the device may define a groove or other indentation 1120 for receiving the secondary solid substrate. A secondary solid substrate may be used to electrospray extracted molecules of interest. A further groove 1122 in the region of tip 1112 of solid substrate 1110, in fluid communication with groove 1120, may be formed to expose the desorption solution, originating from groove 1120, containing the desorbed molecules of interest to be ionized and expelled from solid substrate 1110. In an embodiment, as shown in FIG. 11, a further groove or channel 1124 may be formed between groove 1120 and groove 1122 to permit fluid communication there between.

A geometrical shape of the groove may allow the generation of ions of the molecules of interest from the second solid substrate rather than from the solid substrate of the device. Any suitable shape that will generate Taylor cone when electric potential is applied may be used. For example, a shape having a tip, such as a triangular edge or a conical shape, or a cylindrical shape for fibers, may be used. The secondary solid substrate may be any suitable type of substrate, including a wire, a pin, and/or a tip. The secondary solid substrate may be coated with an extraction material. The secondary solid substrate may be an SPME, a probe electrospray ionization (PESO, or micro-SPME device.

The secondary solid substrate may comprise an extraction phase, such as a coating, and molecules of interest may have been previously adsorbed onto the extraction phase of the secondary solid substrate. After the secondary solid substrate is placed into a groove of the solid substrate of the device, desorption solvent may be added to the groove to desorb the molecules of interest from the extraction phase of the secondary solid substrate.

FIG. 12 illustrates a holder 1200 for multiple spray devices 1202 for use with a mass spectrometer. In this embodiment, holder 1200 is in the form of a ribbon-like structure. Holder 1200 may receive and hold any suitable number of spray ionization devices. In an embodiment, holder 1200 may receive up to 96 blade spray devices. In an embodiment, holder 1200 may enable the plurality of blade devices to be moved sequentially in front of a mass spectrometer. This may be a partly or fully automated process. Holder 1200 may comprise a moldable polymer that allows accommodating one or more spray devices 1202 having diverse geometrical shapes. Holder 1200 may comprise, or cooperate with, a spring loading based system (not shown) for independently connecting a voltage source to one or more of the spray devices 1202 to allow for rapid and easy spray device use and replacement.

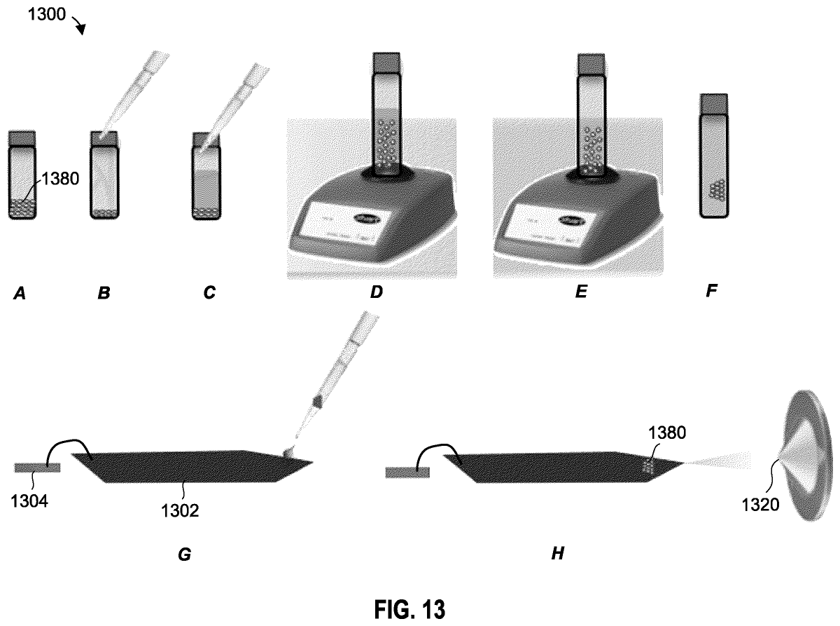

FIG. 13 is an illustration of an experimental setup and process 1300 used in an example for magnetic blade-spray desorption and ionization using a spray device 1302. Device 1302 had a copper strip and was electrically connected to an electrical source 1304.

Liquid chromatography-mass spectrometry (LC-MS) grade methanol (MeOH), acetonitrile (ACN), water and isopropanol (IPA) were provided by Fisher scientific. Codeine, cocaine, buprenorphine, clenbuterol, sertraline, oxycodone, fentanyl, bisoprolol, citalopram, diazepam, propranolol, carbamazepine, methamphetamine was purchased from Sigma Aldrich (Oakville, ON, Canada). The magnetic particles used for extractions were manufactured using an in-house synthesis procedure. The coatings were hydrophilic-lipophilic balance (HLB) particles microspheres in the range of 100 nm-200 μm. The experiments were performed on triple quadrupole TSQ Quantiva™ from Thermo Scientific™ (San Jose, Calif., USA). All the experiments were run on a source custom built at the University of Waterloo for coated blade spray experiments.

Phosphate buffer saline (PBS), urine and plasma samples were spiked with concentrations of codeine, cocaine, buprenorphine, clenbuterol, sertraline, oxycodone, fentanyl, bisoprolol, citalopram, diazepam, propranolol, carbamazepine, methamphetamine ranging between 0.5 and 100 ng mL⁻¹. All employed internal standards were spiked at 10 ng mL⁻¹. The samples were agitated and store for three hours for equilibration.

Magnetic HLB particles synthesized in-house were used for extracting drugs of abuse from PBS, urine and plasma samples. PBS and urine samples were spiked with drugs of abuse at the concentration ranging from 0.5 to 100 ng mL⁻¹. Internal standards were spiked at a concentration of 10 ng mL⁻¹.

At stage A, as labeled in FIG. 13, MHLB particles 1380 were conditioned. 30 mg magnetic HLB (MHLB) particles were weighed in a headspace vial.

At stage B, the MHLB particles were dispersed in 10 mL ACN on a vortex shaker. 50 μL of this solution was transferred to get 150 μg MHLB particles in the vial. This procedure was repeated each time before transferring magnetic particles to ensure same quantity of particles for each analysis.

At stage C, to this vial, 300 μL of matrix (PBS, urine or plasma) was added.

At stage D, the contents of the vial were vortexed for 15 minutes at 3200 rpm to disperse and perform extraction.

At stage E, supernatant was removed and the MHLB particles were washed with 100 μL water for 5 seconds.

At stage F, the extraction process was terminated by collecting the MHLB particles on the walls of vial under the influence of external magnetic field applied using rare earth magnets.

At stage G, the MHLB particles were transferred to the magnetic blade spray device 1302. The molecules of interest were dispersed in 20 μL MeOH:H₂O (95:5) with 10 mM ammonium acetate and 0.1% formic acid. In another experiment, 10 μL rather than 20 μL of solution was used.

At stage H, an electric potential of around 5500 V was applied to the copper strip on the solid substrate to ionize and expel the molecules of interest from the solid substrate towards an inlet of a mass spectrometer.

Table 1, below, sets forth figures of merit for the quantitation of multiple analytes in human urine via magnetic blade spray according to the example of FIG. 13.

TABLE 1

| | | | | | Accuracy (n = 3), % | | | Precision (n = 3), % | | |
|---|---|---|---|---|---|---|---|---|---|---|
| | | | | LOQ | 3 | 30 | 90 | 3 | 30 | 90 |
| Compound | Slope | Intercept | R² | (ng · mL⁻¹) | ng · mL⁻¹ | ng · mL⁻¹ | ng · mL⁻¹ | ng · mL⁻¹ | ng · mL⁻¹ | ng · mL⁻¹ |
| Methamphetamine | 0.0679 | 0.02726 | 0.9991 | 1.0 | 109.69 | 89.20 | 94.08 | 2.5 | 2.1 | 1.5 |
| Carbamazepine | 0.0955 | −0.04043 | 0.9993 | 1.0 | 101.10 | 91.97 | 91.91 | 1.2 | 1.6 | 3.5 |
| Propranolol | 0.1973 | −0.06035 | 0.9989 | 0.5 | 95.40 | 94.54 | 94.44 | 3.3 | 1.9 | 1.5 |
| Clenbuterol | 0.0666 | 0.08204 | 0.9990 | 1.0 | 94.57 | 94.45 | 93.95 | 0.6 | 2.7 | 1.1 |
| Diazepam | 0.0922 | −0.00527 | 0.9992 | 1.0 | 96.73 | 92.09 | 90.95 | 1.9 | 1.8 | 2.2 |
| Codeine | 0.0451 | 0.20768 | 0.9998 | 0.5 | 107.67 | 102.94 | 96.32 | 14.2 | 10.4 | 4.9 |
| Cocaine | 0.0883 | −0.00482 | 0.9984 | 0.5 | 89.27 | 94.73 | 93.67 | 3.2 | 2.5 | 0.4 |
| Sertraline | 0.0525 | −0.00895 | 0.9992 | 1.0 | 99.04 | 92.44 | 90.11 | 2.6 | 3.2 | 0.9 |
| Citalopram | 0.0832 | −0.01758 | 0.9992 | 0.5 | 91.71 | 95.88 | 91.89 | 1.4 | 3.7 | 0.3 |
| Fentanyl | 0.0610 | −0.00451 | 0.9987 | 0.5 | 87.06 | 93.66 | 92.06 | 1.3 | 1.5 | 1.2 |
| Buprenorphine | 0.6794 | −0.04961 | 0.9931 | 0.5 | 94.94 | 93.91 | 93.28 | 4.0 | 8.6 | 6.8 |
| Bisoprolol | 0.0009 | 0.00108 | 0.9992 | 1.0 | 89.22 | 94.24 | 89.82 | 15.7 | 4.1 | 4.6 |

Table 2, below, sets forth figures of merit for the quantitation of multiple analytes in human plasma via magnetic blade spray according to the example of FIG. 13.

TABLE 2

| | | | | | Accuracy (n = 3), % | | | Precision (n = 3), % | | |
|---|---|---|---|---|---|---|---|---|---|---|
| | | | | LOQ | 3 | 30 | 90 | 3 | 30 | 90 |
| Compound | Slope | Intercept | R² | (ng · mL⁻¹) | ng · mL⁻¹ | ng · mL⁻¹ | ng · mL⁻¹ | ng · mL⁻¹ | ng · mL⁻¹ | ng · mL⁻¹ |
| Methamphetamine | 0.0796 | −0.04966 | 0.9996 | 2.5 | 103.68 | 96.61 | 105.11 | 4.0 | 2.6 | 9.3 |
| Carbamazepine | 0.1011 | 2.41495 | 0.9978 | 1.0 | 90.08 | 95.77 | 102.83 | 3.9 | 0.8 | 3.9 |
| Propranolol | 0.1994 | −0.12243 | 0.9996 | 1.0 | 103.07 | 95.82 | 105.66 | 3.6 | 3.7 | 0.9 |
| Clenbuterol | 0.0752 | −0.02643 | 0.9991 | 1.0 | 115.90 | 94.55 | 101.84 | 20.9 | 5.3 | 1.9 |
| Diazepam | 0.0931 | 0.01240 | 0.9994 | 0.5 | 102.54 | 96.51 | 106.68 | 13.6 | 3.1 | 4.7 |
| Codeine | 0.0834 | −0.00990 | 0.9993 | 0.5 | 95.67 | 101.75 | 92.98 | 3.1 | 7.0 | 1.9 |
| Cocaine | 0.1098 | 0.04140 | 0.9992 | 0.5 | 95.16 | 101.15 | 105.30 | 18.0 | 3.1 | 1.9 |
| Sertraline | 0.0582 | −0.01251 | 0.9989 | 1.0 | 108.70 | 96.28 | 102.70 | 6.3 | 2.1 | 6.3 |
| Citalopram | 0.1045 | −0.02594 | 0.9997 | 1.0 | 94.33 | 97.25 | 103.53 | 1.9 | 4.5 | 4.3 |
| Fentanyl | 0.0641 | −0.02730 | 0.9998 | 0.5 | 96.15 | 98.61 | 104.43 | 3.3 | 3.5 | 1.7 |
| Bisoprolol | 0.0011 | 0.00039 | 0.9999 | 0.5 | 114.32 | 90.75 | 103.44 | 26.6 | 15.6 | 6.2 |

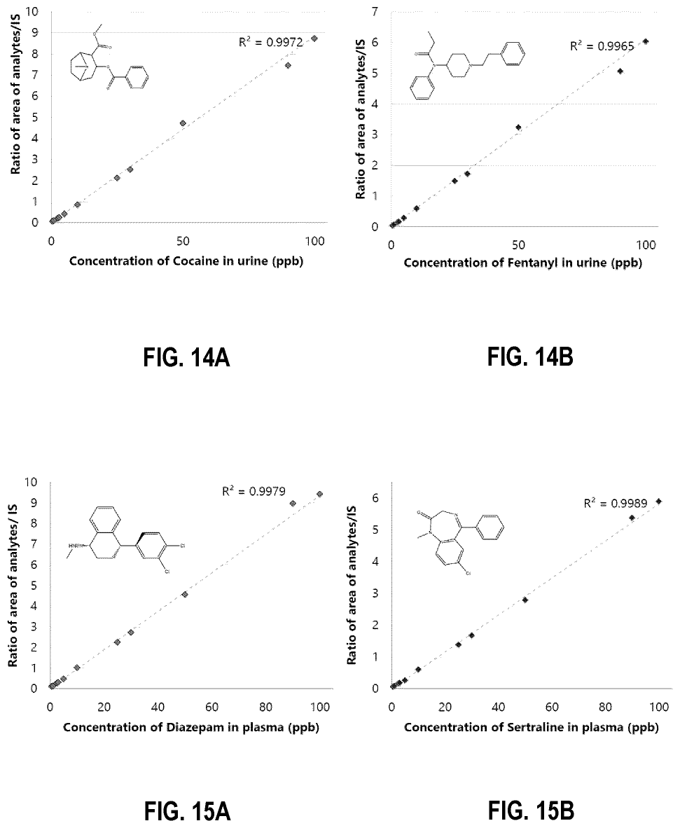

FIG. 14A is a linear regression graph illustrating quantitative analysis of 300 μL of a human urine sample spiked with cocaine.

FIG. 14B is a linear regression graph illustrating quantitative analysis of 300 μL of a human urine sample spiked with fentanyl.

FIG. 15A is a linear regression graph illustrating quantitative analysis of 300 μL of a human plasma sample spiked with diazepam.

FIG. 15B is a linear regression graph illustrating quantitative analysis of 300 μL of a human plasma sample spiked with sertraline.

The analyses used in regard to the graphs of FIGS. 14A-15B were performed using magnetic blade spray-tandem mass spectrometry (MBS-MS/MS).

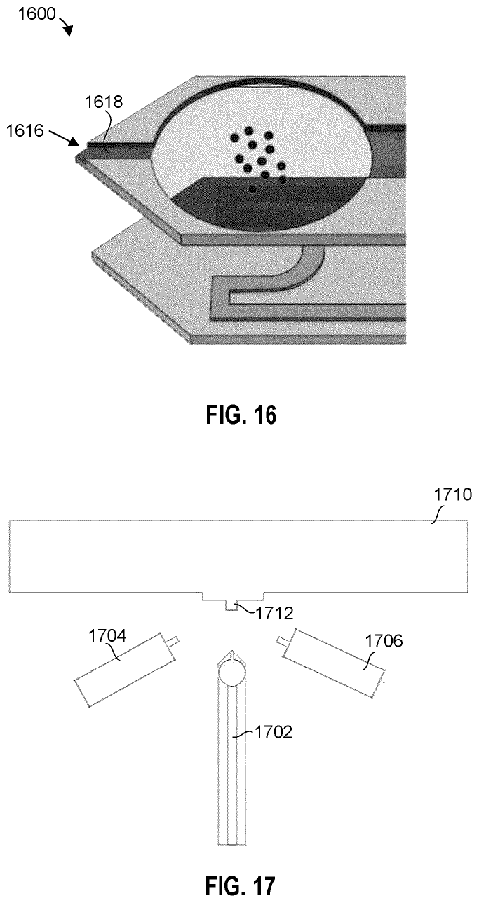

FIG. 16 is a semi-transparent, exploded view of an example blade spray device 1600 similar to the device 700 shown in FIG. 7. However, in device 1600, channel or groove 1616 comprises a layer of clean-up phase 1618. Clean-up phase may be placed there for removing unwanted molecules, for example molecules originating from the sample matrix, so that these unwanted molecules do not get sprayed into the mass spectrometer. Clean-up phase 1618 may not adsorb the molecules of interest, or if it does, then desorption solvent will desorb the molecules of interest from the surface of clean-up phase 1618 but unwanted molecules will remain on clean-up phase 1618. Clean-up phase 1618 may comprise a polymeric phase, a polymer-metal oxide, and/or metallic particles, for the selective removal of undesired molecules and/or the selective enrichment of desired molecules. Examples of polymer-metal oxide for removal of undesired molecules include but are not limited to zirconia oxide particles or titanium oxide particles. Polymeric extractions may be made of smart materials, metal composites, and/or polymer-metal composites, among others.

In some embodiments, devices and methods herein described simultaneously isolate and enrich the analytes present in a fluid. Coatings on solid substrates used in the present disclosure may stabilize analytes that are extracted therein. Since the coating may be adjusted towards molecules of interest, devices and methods disclosed herein may reduce undesirable artefacts that may provide ion suppression or enhancement. Since the sample is not placed in front of the mass spectrometer, devices and methods disclosed herein may provide sample normalization.

FIG. 17 is a diagram of a blade spray system having a mass spectrometer 1710, a blade spray ionization device 1702, and two additional sprayers. One of the additional sprayers is a cleaning sprayer 1704 for mass spectrometry cleaning. The other additional sprayer 1706 is for analyte derivatization and/or mass spectrometry calibration.7

In particular, cleaning sprayer 1704 may be based on the Venturi effect, which allows the administration of continuous solvent microdroplets to the entrance of mass spectrometer 1710, facilitating the removal of any remaining analyte potentially adhered to the surface of the mass spectrometer inlet 1712.

Further, a mass spectrometer or an ion mobility system may be calibrated while performing an instrumental sequence with a blade spray device. Additional sprayer 1706 may comprise an electrospray ionization sprayer based on the Venturi effect which allows the administration of calibrant solution or reagent in the gas phase to inlet 1712 of mass spectrometer 1710. This allows the calibration of the mass spectrometer system, such time of flight systems, without needing to change the ionization interface. For example, calibration may correct for drifts either in mass to charge ratio in mass spectrometry instrumentation and/or mobility by ion mobility instrumentation.

Further, additional sprayer 1706 may be used for derivatization of expelled ions in gas phase when performing spray ionization. Additional sprayer 1706 is based on the Venturi effect, which allows the administration of continuous solvent microdroplets close to inlet 1712 of mass spectrometer 1710 containing a derivatization reagent in an angle to the trajectory of the ionization electrospray generated by the solid substrate of spray ionization device 1702. The introduction of the derivatization reagent allows the generation of product species in the gas phase. and analyzing the expelled derivatized and non-derivatized ions by mass spectrometry. Subsequently, the mass spectrometer may analyze both the expelled derivatized and non-derivatized ions. The configuration may enhance the sensitivity of poor ionizers or compounds with low mass to charge ratios.

Further, according to the present disclosure, a mass spectrometry system is provided. The system comprises an ionization device, such as one according to the present disclosure, with a solid substrate. A desorption solvent may cover at least a portion of the solid substrate where is located either an extraction phase, extraction magnetic particles, a sample deposition area, a clean-up area, or any combination thereof. The system may further comprise an independent high voltage source to generate electrospray, an independent current source to generate heat, an independent current source to generate vibration, and a discontinuous solvent supply. The system may comprise a holder where the solid substrate may be connected to either high voltage, high current, low current, and either desorption solvent or stacking solvent. The system may comprise a holder supporting one Venturi sprayer, a holder supporting one ESI sprayer supported by Venturi effect, and a mass analyzer. The device may be connected via a holder to independently supply the solid substrate with either high voltage, high current, or low current, and the desorption or stacking solvent may be applied to the device before and during ionization.

Further, example methods utilizing an ionization device according to the present disclosure are provided.

In particular, example methods for analyzing molecules previously collected on an ionization device, such as one according to the present disclosure, are now described.

An example method comprises applying desorption solution to a portion of a solid substrate of the device where extraction phase is located, or to a sample deposition area, or to a clean-up area, or any combination thereof. The method further comprises desorbing the molecules of interest, and applying vibration, heating, and/or stacking voltage to the solid substrate to promote efficient desorption of the extracted molecules. The method further comprises applying voltage to the device that is sufficiently high to expel ions of molecules from the solid substrate, while keeping the solid substrate separate from a flow of solvent. The method further comprises analyzing the expelled ions by mass spectrometry.

An example method comprises applying a stacking solvent in a non-coated groove of the device which is closer in regard to the mass spectrometer inlet. The method further comprises applying desorption solution to a portion of a solid substrate of the device where extraction phase is located, or to a sample deposition area, or to a clean-up area, or any combination thereof. The method further comprises desorbing the molecules of interest, and applying vibration, heating, and/or stacking voltage to the solid substrate to promote efficient desorption of the extracted molecules. The method further comprises applying voltage, or voltage waves, to the device that is sufficiently high to stack molecules previously collected on the solid substrate. The method further comprises applying voltage to the device that is sufficiently high to expel ions of molecules from the solid substrate, while keeping the solid substrate separate from a flow of solvent. The method further comprises analyzing the expelled ions by mass spectrometry.

An example method comprises applying desorption solution to a portion of a solid substrate of the device where extraction phase is located, or to a sample deposition area, or to a clean-up area, or any combination thereof. The method further comprises desorbing the molecules of interest, and applying vibration, heating, and/or stacking voltage to the solid substrate to promote efficient desorption of the extracted molecules. The method further comprises applying voltage, or voltage waves, to the device that is sufficiently high to stack molecules previously collected on the solid substrate. The method further comprises applying voltage to the device that is sufficiently high to expel ions of molecules from the solid substrate, while keeping the solid substrate separate from a flow of solvent. The method further comprises analyzing the expelled ions by mass spectrometry.

An example method comprises applying desorption solution to a portion of a solid substrate of the device where extraction phase is located, or to a sample deposition area, or to a clean-up area, or any combination thereof. The method further comprises desorbing the molecules of interest, and applying vibration, heating, and/or stacking voltage to the solid substrate to promote efficient desorption of the extracted molecules. The method further comprises applying voltage to the device that is sufficiently high to expel ions of molecules from the solid substrate, while keeping the solid substrate separate from a flow of solvent. The method further comprises applying a derivatization reagent in a gas phase close to the mass spectrometer inlet via a venturi sprayer with an angle to the trajectory of the solid substrate spray which allows the generation of product species in the gas phase. The method further comprises analyzing the expelled derivatized and non-derivatized ions by mass spectrometry.

An example method comprises attaching a secondary coated solid substrate into a groove of the solid substrate. The method further comprises applying a desorption solution to a portion of the coated area of the secondary solid substrate. The method further comprises desorbing the molecules of interest from the extraction phase of the secondary solid substrate. The method further comprises applying vibration, heating, and/or stacking voltage to the solid substrate to promote efficient desorption of the extracted molecules. The method further comprises applying voltage to the device that is sufficiently high to expel ions of molecules from the solid substrate, while keeping the solid substrate separate from a flow of solvent. The method further comprises analyzing the expelled ions by mass spectrometry.

An example method comprises applying a calibration reagent in a gas phase close to the mass spectrometer inlet via electrospray supported by venturi effect to correct for drifts either in mass to charge ratio in mass spectrometry instrumentation and/or mobility by ion mobility instrumentation. The method further comprises, once the mass spectrometer has been calibrated, applying desorption solution to a portion of a solid substrate of the device where extraction phase is located, or to a sample deposition area, or to a clean-up area, or any combination thereof. The method further comprises desorbing the molecules of interest, and applying vibration, heating, and/or stacking voltage to the solid substrate to promote efficient desorption of the extracted molecules. The method further comprises applying voltage to the device that is sufficiently high to expel ions of molecules from the solid substrate, while keeping the solid substrate separate from a flow of solvent. The method further comprises analyzing the expelled ions by mass spectrometry.

According to another aspect of the present disclosure, methods and devices for directly coupling sample preparation, such as extraction phase, to a mass spectrometer is provided. The solid substrate of the spray ionization device may comprise an indentation for receiving the extraction phase and desorption solution. The extraction phase, containing molecules of interest, may then be introduced directly onto the spray ionization device. The extraction phase may be in liquid or solid form. The molecules of interest may have been previously extracted from a sample onto the extraction phase prior to the extraction phase being deposited onto the spray ionization device. In this way, the spray ionization device is not used to perform both the extraction and the desorption/electrospray stages. A result is that the extraction stage is not limited to the particular characteristics and geometry of the spray ionization device. Further, the shape of the spray ionization device may be modified to enhance its spray ionization performance. Further, ionization may be enhanced by using atmospheric pressure chemical ionization and/or photoionization in place of or in addition to electrospray ionization.

In an embodiment, solvent containing molecules of interest, or extraction phase containing molecules of interest, are placed into the indentation in the solid substrate. Desorption solution is also be added.

In some embodiments, formats of extraction phase include coated fiber, coated thin film microextraction (TFME), and extraction phase coated magnetic particles. Further, droplets of the extraction solvent may be deposited into the indentation of the ionization device. The extraction phase may be loaded with an internal standard.

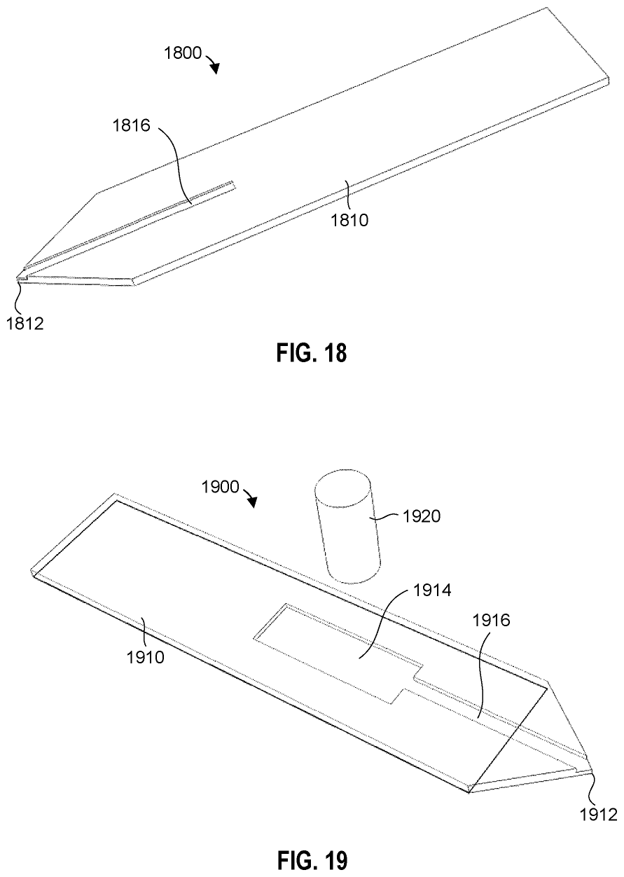

FIG. 18 is an example blade spray device 1800 for generating ionized molecules for analysis in a mass spectrometer. Device 1800 comprises a solid substrate 1810, and device 1800 may be similar in part to other devices described herein. Further, solid substrate 1810 may define an indentation in the form of a channel 1816 for receiving extraction phase and desorption solution. Channel 1816 may channel desorption solution containing desorbed molecules of interest toward tip 1812 of solid substrate 1810 for ionization.

Embodiments similar to that of FIG. 18 may be suited for smaller volumes of extraction phase, whether liquid or solid, that will fit substantially in channel 1816. The physical dimensions of channel 1816, and thus its volume, may vary from embodiment to embodiment. Alternatively, for larger volumes of extraction phase, an embodiment similar to the one of FIG. 19 may be used.

FIG. 19 is an example blade spray device 1900 comprising a solid substrate 1910. Device 1900 may be similar in part to other devices described herein. Further, solid substrate 1910 may define an indentation, which may be at least partly in the form of a compartment 1914, for example for receiving extraction phase containing desorption solution and molecules of interest, and/or a channel 1916 for channeling desorption solution containing desorbed molecules of interest toward tip 1912 of solid substrate 1910 for ionization. The physical dimensions of compartment 1914, and thus its volume, may vary from embodiment to embodiment, for example depending on the nature and volume of the extraction phase to be received. Compartment 1914 may have a square or rectangular cross-section. Similarly, the physical dimensions of channel 1916, and thus its volume, may vary from embodiment to embodiment.

Optionally, a delivery device 1920 may be used to deliver the extraction phase to compartment 1914. An example delivery device may be a magnet where the extraction phase comprises magnetic particles, such as for example sorbent coated magnetic particles. Further, delivery device 1920 may be used to deliver solvent containing molecules of interest to compartment 1914. Delivery device 1920 may be operated by an automated system in a high throughput application performing sampling, extraction and delivery of the extraction phase to device 1900. Further, delivery device 1920 may deliver desorption solution to compartment 1914 via a channel or tubing contained in delivery device 1920.

In some embodiments, rather than solid substrate 1910 defining a channel 1916 and/or compartment 1914, the shape of solid substrate 1910 may be comprise a non-uniform thickness such that tip 1912 has a smaller thickness relative to the rest of solid substrate 1910 thereby creating a slope to lead by gravity the desorption solution containing the molecules of interest toward tip 1912. The same applies to other embodiments described herein, including embodiments according to FIG. 18. In an embodiment, device 1900 may be positioned at an angle from level such that tip 1912 is below the rest of solid substrate 1910 to lead by gravity the desorption solution containing the molecules of interest toward tip 1912.

In some embodiments, solid substrate 1910 has a homogeneous thickness in the range of about 0.01 mm to about 2 mm. In some embodiments, solid substrate 1910 has a length in the range of about 1 cm to about 10 cm, a width in the range of about 0.1 mm to about 5 mm, and/or a thickness in the range of about 0.1 mm to about 2 mm. In an embodiment, solid substrate 1910 comprises of a metal, a metal alloy, or a polymer. In an embodiment, solid substrate 1910 may comprise a magnetic portion for collecting and retaining magnetic extraction phase. In an embodiment, channel 1916 may have a diameter within the approximate range of 100 nm to 10 mm to deliver the desorption solution to tip 1912.

Spray device 1900 may be vibrated, for example using sonic waves (sonic spray) and/or positioned directly in front of mass spectrometer to promote the formation of small droplets, such as nanosized droplets, and therefore reduce a matrix effect of direct mass spectrometer introduction. The droplets can be reduced to a small enough size that each droplet consists of only one molecule thereby eliminating competition for the charges between molecules. Such an approach eliminates a matrix effect causing the suppression of a signal associated with target molecules resulting from undesired molecules being sprayed into the mass spectrometer in the same droplet. In between uses, spray device 1900 may be cleaned using a cleaning solvent to avoid cross contamination. This may be done using delivery device 1920 as a means of delivering the cleaning solvent. Alternatively, a number of spray devices 1900 may be placed one by one at a time in front of the mass spectrometer and connected in a ribbon-like manner such as is described with reference to FIG. 12. This may ensure that desorption and electrospray are performed separately for each extraction phase for critical applications if cross contamination is of concern.

In some applications, a relatively small volume of desorption solvent may be used with a goal of achieving high enrichment, resulting in an increase of analyte concentration and higher determination sensitivity. On the other hand, if multicomponent quantification is to be performed, then more solvent may be used to support long electrospray times with a goal of to ensuring sufficient time to quantify all analytes.

Further, in some embodiments, the ionization source is electrospray ionization, chemical ionization, photoionization, or a combination thereof. To enhance the ionization efficiency, in addition to electrospray ionization, chemical ionization or photoionization may be used separately or jointly.

A mass spectrometry system is provided comprising an ionization device, an extraction phase deposited onto the device, a desorption solvent deposited onto and covering at least a portion of the extraction phase, a voltage source, and a mass analyzer. The ionization device is connected to the voltage source, and no solvent is applied to the device during ionization.

Further, an example method utilizing an ionization device according to FIG. 18 or 19 is provided. In particular, a method for analyzing a molecule previously extracted from a sample onto an extraction phase may comprise placing the extraction phase in an indentation of the device. The indentation may be a channel or a compartment. A voltage is applied to the device that is sufficiently high to electrospray solvent containing desorbed molecules of interest into an inlet of a mass spectrometer. The formed ions may then be analyzed by mass spectrometry. In an embodiment, desorption solution may be added to the indentation in addition to the extraction phase. In an embodiment, the volume of the desorption solution is in the approximate range of 1 nL to 100 μL compared to the extraction phase to promote high enrichment and high sensitivity.

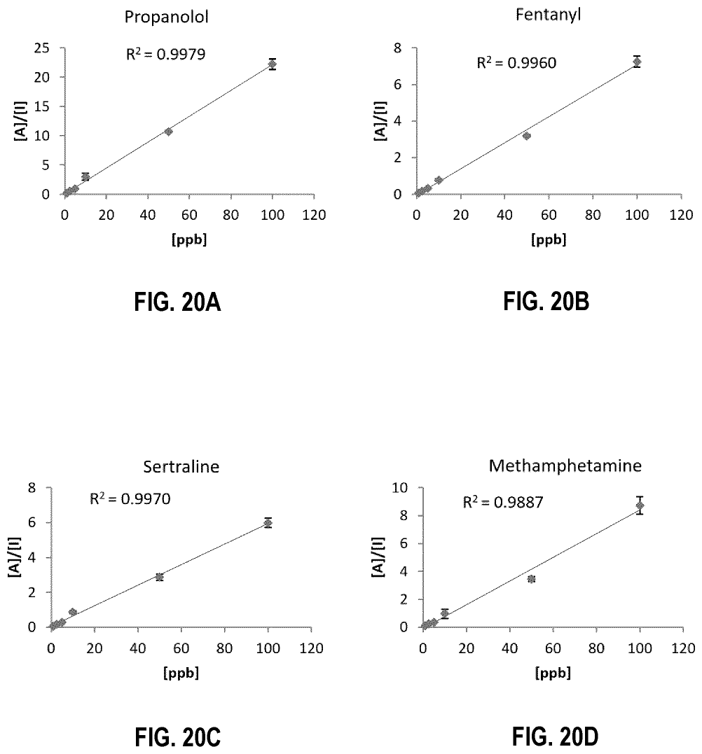

FIGS. 20A-20D are linear regression graphs illustrating quantitative analysis of human urine samples spiked with propranolol, fentanyl, sertraline, and methamphetamine, respectively, in an example. A device similar to device 1100 shown in FIG. 11 was used. Analyses were performed using direct blade spray-tandem mass spectrometry (DBS-MS/MS).

In particular, human urine samples were spiked with concentrations of propranolol, fentanyl, sertraline, methamphetamine ranging between 0.5 and 100 ng mL⁻¹. All employed internal standards were spiked at 10 ng mL⁻¹. The samples were agitated and store for 3 hours for equilibration.

A secondary solid substrate coated with extraction phase having a tip was used to extract the spiked compounds from human urine samples. The secondary solid substrate was dipped into the spiked human urine sample and extraction was performed for 15 min.

After extraction, the solid substrate was washed with 100 μL water for 5 seconds and then was placed on the direct blade spray device 1100 into the groove 1120 where the coated tip portion of secondary solid substrate was protruding outside tip 1112 of device 1100.

The desorption solution was placed at 1122 tip of the secondary solid substrate and desorption was performed.

Electric potential was applied to the secondary solid substrate and electrospray was generated at the tip of secondary solid substrate to ionize and introduce the molecules of interest into the mass spectrometer.

FIG. 20A is a linear regression graph illustrating quantitative analysis of 300 μL of a human urine sample spiked with propranolol.

FIG. 20B is a linear regression graph illustrating quantitative analysis of 300 μL of a human urine sample spiked with fentanyl.

FIG. 20C is a linear regression graph illustrating quantitative analysis of 300 μL of a human urine sample spiked with sertraline.

FIG. 20D is a linear regression graph illustrating quantitative analysis of 300 μL of a human urine sample spiked with methamphetamine.

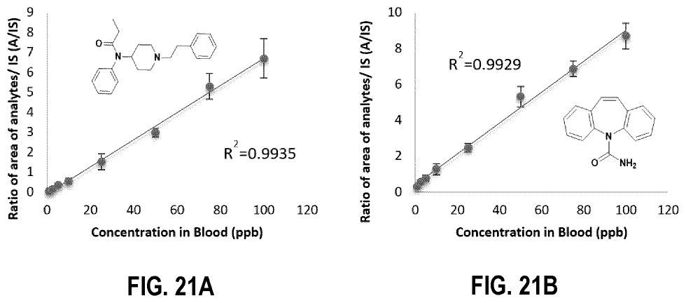

FIGS. 21A-B are linear regression graphs illustrating quantitative analysis of human blood samples spiked with fentanyl and diazepam, respectively, in an example. A magnetic spray ionization device similar to device 500 shown in FIG. 5 was used. Analyses were performed using magnetic blade spray-tandem mass spectrometry (MBS-MS/MS). An example process similar to the process 850 of FIG. 8B was used.

In particular, human blood samples were spiked with concentrations of cocaine, fentanyl, diazepam, carbamazepine, methamphetamine to get concentration ranging between 0.5 and 100 ng mL⁻¹. All employed internal standards were spiked at 10 ng mL⁻¹ final concentration. The samples were agitated and stored overnight for equilibration.

Magnetic hydrophilic-lipophilic balance (MHLB) particles synthesized in-house were used for extracting drugs of abuse from spiked blood samples.

This example is now further described with general reference to FIG. 8B, but noting that a spray ionization device similar to device 500 shown in FIG. 5 was used rather than device 860 show in FIG. 8B. At stage A, as labeled in FIG. 8B, 150μg of MHLB particles 890 was transferred from suspension of 30 mg MHLB particles pre weighed in a headspace vial. To this solution, 100 μL spiked blood was added and vortexed for 15 min to perform extraction.

At stage B, the extraction procedure was terminated by collecting the MHLB particles dispersed in 100 μL blood sample by collecting them on the spray ionization device.

At stage C, magnetic device 500 holding the magnetic particles close to the tip of the spray ionization device was washed twice with 100 μL water for 5 seconds in a separate vial.

At stage D, the magnetic spray ionization device was positioned in front of mass spectrometer and the molecules of interest were desorbed from the MHLB particles by applying 20 μl desorption solvent 818, MeOH:H₂O (95:5) with 10 mM ammonium acetate and 0.1% formic acid.

At stage E, an electric potential of around 5500 V was applied to the conductive strip on the solid substrate to ionize and expel the molecules of interest from the solid substrate towards an inlet 820 of a mass spectrometer. The molecules of interest were then analyzed using the mass spectrometer.

FIG. 21A is a linear regression graph illustrating quantitative analysis of 100 μL of a human blood sample spiked with fentanyl. FIG. 21B is a linear regression graph illustrating quantitative analysis of 100 μL of a human blood sample spiked with diazepam.

Table 3, below, sets forth figures of merit for the quantitation of multiple analytes in human blood via magnetic blade spray-tandem mass spectrometry (MBS-MS/MS) according to the examples of FIG. 21A-B.

TABLE 3

| | | | | | Accuracy (n = 3), % | | Precision (n = 3), % | |
|---|---|---|---|---|---|---|---|---|
| | | | | LOQ | 30 | 90 | 30 | 90 |
| Compound | Slope | Intercept | R² | (ng · mL⁻¹) | ng · mL⁻¹ | ng · mL⁻¹ | ng · mL⁻¹ | ng · mL⁻¹ |
| Methamphetamine | 0.0910 | 1.13005 | 0.9527 | 2.5 | 130.73 | 80.89 | 4.4 | 4.9 |
| Carbamazepine | 0.0860 | 0.39284 | 0.9929 | 1.0 | 113.07 | 119.58 | 11.6 | 7.6 |
| Diazepam | 0.1189 | 0.24283 | 0.9867 | 1.0 | 82.13 | 80.10 | 26.0 | 6.4 |
| Cocaine | 0.0721 | −0.15513 | 0.9738 | 1.0 | 61.33 | 57.66 | 29.8 | 9.0 |
| Fentanyl | 0.0717 | −0.14685 | 0.9935 | 1.0 | 79.57 | 95.27 | 6.6 | 14.2 |

It is noted that while some embodiments described herein consist or comprise a blade ionization spray device, this is not intended to be limiting. The teachings of the present disclosure contemplate and apply to types of devices other than blade-type spray devices. Further, while some embodiments described herein comprise or are based on electrospray ionization, this is not intended to be limiting. The teachings of the present disclosure contemplate and apply to types of ionization devices and techniques other than electrospray ionization, including but not limited to photoionization ionization and/or atmospheric pressure chemical ionization.

In the preceding description, for purposes of explanation, numerous details are set forth in order to provide a thorough understanding of the embodiments. However, it will be apparent to one skilled in the art that these specific details are not required. In other instances, well-known structures, processes, and/or techniques are not described in order not to obscure the understanding.

The structure, features, accessories, and alternatives according to specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

In addition, the steps and the ordering of the steps of methods and data flows described and/or illustrated herein are not meant to be limiting. Methods and data flows comprising different steps, different number of steps, and/or different ordering of steps are also contemplated. Furthermore, although some steps are shown as being performed consecutively or concurrently, in other embodiments these steps may be performed concurrently or consecutively, respectively.

For simplicity and clarity of illustration, reference numerals may have been repeated among the figures to indicate corresponding or analogous elements. Numerous details have been set forth to provide an understanding of the embodiments described herein. The embodiments may be practiced without these details. In other instances, well-known methods, procedures, and components have not been described in detail to avoid obscuring the embodiments described.

The above-described embodiments are intended to be examples only. Alterations, modifications and variations may be effected to the particular embodiments by those of skill in the art without departing from the scope, which is defined solely by the claims appended hereto.

1. A device for generating ionized molecules of interest for analysis in a mass spectrometer, the device comprising:
a solid substrate having one or more edges for spray ionization, the solid substrate defining an indentation for receiving desorption solvent and extraction phase containing the molecules of interest.

2. The device of claim 1, wherein at least part of the indentation is in the form of a channel extending to an edge of the solid substrate for guiding desorption solvent containing the molecules of interest towards the edge for spray ionization.

3. The device of claim 2, wherein the channel is disposed at a tip of the solid substrate for guiding desorption solvent containing the molecules towards the tip.

4. The device of claim 2, wherein at least part of the indentation is in the form of a compartment for receiving the desorption solvent and extraction phase, wherein the compartment is connected to the channel.

5. The device of claim 1, wherein a region of the solid substrate defining the indentation comprises no extraction phase.

6. The device of claim 1, wherein the solid substrate comprises no extraction phase prior to receiving the extraction phase comprising the molecules of interest.

7. The device of claim 1, wherein the solid substrate comprises a magnetic portion for attracting magnetic particles of an extraction phase deposited on the solid substrate.

8. The device of claim 7, wherein the magnetic portion at least partly aligns with the indentation.

9. The device of claim 1, wherein the solid substrate has a tip having a substantially triangular shape and being defined by at least two edges that meet at an angle from about 8 degrees to about 90 degrees.

10. The device of claim 1, wherein the solid substrate has a homogeneous thickness from about 0.01 mm to about 2 mm.

11. The device of claim 1, wherein the solid substrate has a length from about 1 to about 10 cm, a width from about 0.1 to about 5 mm, and a thickness from about 0.1 mm to about 2 mm.

12. The device of claim 1, wherein the solid substrate comprises at least one of a metal, a metal alloy, and a polymer.

13. The device of claim 1, wherein the indentation has a substantially square or rectangular cross-section.

14. A method for analyzing molecules previously extracted from a sample onto an extraction phase using a device according to claim 1, comprising:
depositing the extraction phase in the indentation of the solid substrate of the device;
applying desorption solvent to desorb the molecules from the extraction phase;
ionizing the desorbed molecules using an ionization source to expel ionized molecules from the solid substrate; and
analyzing the formed ions by mass spectrometry.

15. The method of claim 14, wherein the extraction phase comprises magnetic particles containing extraction polymer.

16. The method of claim 14, wherein during ionization no solvent is applied to the device.

17. The method of claim 14, wherein the extraction phase is located on a secondary solid substrate device, the method comprising depositing the secondary solid substrate device in the indentation.

18. The method of claim 17, wherein the ionization source in conjunction with the desorption solvent is used to desorbed molecules from the secondary solid substrate device.

19. The method of claim 14, further comprising vibrating the solid substrate to promote ionization of the molecules.

20. A method of manufacturing a device for generating ionized molecules of interest for analysis in a mass spectrometer, the method comprising:
providing a solid substrate having one or more edges for spray ionization; and
forming an indentation in the solid substrate for receiving desorption solvent.

21. The method of claim 20, wherein at least part of the indentation is in the form of a channel extending to an edge of the solid substrate for guiding desorption solvent containing the molecules of interest towards the edge for spray ionization.

22. The method of claim 21, wherein the channel is disposed at a tip of the solid substrate for guiding desorption solvent containing the molecules towards the tip.

23. The method of claim 21, wherein at least part of the indentation is in the form of a compartment for receiving the desorption solvent and extraction phase, wherein the compartment is connected to the channel.

24. A device for generating ionized molecules of interest for analysis in a mass spectrometer, the device comprising:
a solid substrate for receiving magnetic particles of an extraction phase, the solid substrate having one or more edges for spray ionization and comprising a magnetic portion for attracting the magnetic particles.

25. The device of claim 24, wherein the magnetic portion comprises the entire solid substrate.

26. The device of claim 24, wherein the magnetic portion comprises a magnet embedded in or on the solid substrate.

27. The device of claim 24, wherein the solid substrate other than the magnetic portion is substantially non-electrically conductive.

28. The device of claim 27, further comprising an electrical conductor extending to an edge or tip region of the solid substrate for applying a voltage to the solid substrate for spray ionization.

29. The device of claim 24, wherein the device further comprises a magnetic shield portion to at least partly shield a portion of the solid substrate from the magnetic field of the magnetic portion.

30. The device of claim 24, further comprising a vibration device for applying vibration to the solid substrate to promote reduction in droplet size and ionization of the molecules of interest.

31. The device of claim 24, further comprising a heating device for applying heat to the solid substrate to promote desorption of the molecules of interest from the extraction phase.

32. The device of claim 24, further comprising a stacking voltage supply for applying a stacking voltage to the solid substrate to concentrate the molecules of interest in a solvent in a region of the solid substrate prior to spray ionization.

33. The device of claim 24, wherein at least a portion of the solid substrate comprises clean-up phase to promote removal of undesired molecules and/or to promote the selective enrichment of the molecules of interest.

34. The device of claim 33, wherein the clean-up phase comprises at least one of a polymer-metal oxide and metallic particles.

35. The device of claim 24, wherein the solid substrate defines an indentation for receiving the magnetic particles.

36. The device of claim 35, wherein the indentation comprises clean-up phase to promote removal of undesired molecules and/or to promote the selective enrichment of the molecules of interest.

37. The device of claim 24, wherein the solid substrate comprises a mesh portion allowing for fluid flow through the solid substrate and capture of magnetic particles.

38. A method for analyzing molecules of interest previously extracted from a sample onto an extraction phase comprising magnetic particles using a device according to claim 24, comprising:
depositing the extraction phase at the magnetic portion of the solid substrate of the device;
applying desorption solvent to desorb the molecules from the extraction phase; ionizing the desorbed molecules using an ionization source to expel the ionized molecules from the solid substrate; and
analyzing the formed ions by mass spectrometry.

39. The method of claim 38, further comprising vibrating the solid substrate to promote ionization of the molecules.

40. The method of claim 38, further comprising heating the solid substrate to promote desorption of the molecules from the extraction phase.

41. The method of claim 38, further comprising applying a stacking voltage to the solid substrate to concentrate the molecules in a solvent in a region of the solid substrate prior to spray ionization.

42. The method of claim 41, wherein the applying the stacking voltage involves applying voltage for a predetermined time to the solid substrate that is below a threshold voltage for causing ionized molecules to be expelled from the solid substrate, then increasing the voltage until ionized molecules are caused to be expelled from the solid substrate.

43. The method of claim 41, further comprising, prior to the applying the stacking voltage, applying a stacking solvent on the solid substrate proximate the desorption solvent, wherein the stacking solvent is different than the desorption solvent.

44. A device for ionizing molecules of interest for analysis in a mass spectrometer, the device comprising:
a solid substrate for receiving particles of an extraction phase comprising the molecules of interest, the solid substrate having one or more edges for spray ionization of the molecules of interest, and comprising no extraction phase prior to receiving the extraction phase particles comprising the molecules of interest.
